(19) United States
(12) Patent Application Publication
(10) Pub. No.: US 2026/0235843 A1
(43) Pub. Date: Aug. 13, 2026

(54) IMAGING LENS ASSEMBLY, CAMERA MODULE AND ELECTRONIC DEVICE

(71) Applicant: LARGAN PRECISION CO., LTD., Taichung City (TW)

(72) Inventors: Hsuan-Chin HUANG, Taichung City (TW); Yu-Chen LAI, Taichung City (TW)

(21) Appl. No.: 19/181,509

(22) Filed: Apr. 17, 2025

Related U.S. Application Data
(60) Provisional application No. 63/640,347, filed on Apr. 30, 2024.

(51) Int. Cl. G02B 7/02

(52) U.S. Cl. CPC G02B 7/021

(57) ABSTRACT

An imaging lens assembly includes a plurality of lens elements, a plastic lens barrel, a frame element and a gap. The lens elements are arranged in order along an optical axis, and include a glass lens element and a first plastic lens element. The plastic lens barrel includes a first inner lateral surface and a first outer lateral surface. The frame element is fixed to the plastic lens barrel, and includes a second inner lateral surface. The gap is formed between the first outer lateral surface and the second inner lateral surface. The imaging lens assembly further includes at least one first annular structure that is disposed on the first inner lateral surface.

### RELATED APPLICATIONS

This application claims priority to U.S. Provisional Application Ser. No. 63/640,347, filed Apr. 30, 2024, which is herein incorporated by reference.

### BACKGROUND

### Technical Field

The present disclosure relates to an imaging lens assembly and a camera module. More particularly, the present disclosure relates to an imaging lens assembly and a camera module applicable to portable electronic devices.

### Description of Related Art

In the recent years, portable electronic devices have developed rapidly. For example, intelligent electronic devices and tablets have been filled in the lives of modern people, and camera modules and imaging lens assemblies mounted on portable electronic devices have also prospered. However, as technology advances, the quality requirements of the imaging lens assemblies are becoming higher and higher. Therefore, an imaging lens assembly, which can guide the deformation direction of the lens elements and maintain the structural strength of the imaging lens assembly, needs to be developed.

### SUMMARY

According to one aspect of the present disclosure, an imaging lens assembly includes a plurality of lens elements, a plastic lens barrel, a frame element and a gap. The elements are arranged in order along an optical axis, and include a glass lens element and a first plastic lens element disposed corresponding to the glass lens element. The first plastic lens element is disposed in the plastic lens barrel, and the plastic lens barrel includes a first inner lateral surface and a first outer lateral surface. The first inner lateral surface surrounds the optical axis, and the first plastic lens element is physically contacted with a first area of the first inner lateral surface. The first outer lateral surface is disposed corresponding to the first inner lateral surface, and farther away from the first plastic lens element than the first inner lateral surface from the first plastic lens element. The frame element is fixed to the plastic lens barrel, and includes a second inner lateral surface. The second inner lateral surface surrounds the optical axis and faces towards the first outer lateral surface, and the second inner lateral surface is physically contacted with a second area of the first outer lateral surface. The gap is formed between the first outer lateral surface and the second inner lateral surface, the gap extends along the optical axis from the second area, and the gap corresponds to the first area. The imaging lens assembly further includes at least one first annular structure which is disposed on the first inner lateral surface, the at least one first annular structure corresponds to the second area, and the at least one first annular structure surrounds the optical axis and extends in a direction away from the frame element.

According to one aspect of the present disclosure, a camera module includes the imaging lens assembly of the aforementioned aspect and an element carrier. The frame element of the imaging lens assembly is fixed in the element carrier.

According to one aspect of the present disclosure, an electronic device includes the camera module of the aforementioned aspect.

According to one aspect of the present disclosure, an imaging lens assembly includes a plurality of lens elements, a plastic lens barrel, a frame element and a gap. The lens elements are arranged in order along an optical axis, and includes a glass lens element and a first plastic lens element disposed corresponding to the glass lens element. The first plastic lens element is disposed in the plastic lens barrel, and the plastic lens barrel includes a first inner lateral surface and a first outer lateral surface. The first inner lateral surface surrounds the optical axis, and the first plastic lens element is physically contacted with a first area of the first inner lateral surface. The first outer lateral surface is disposed corresponding to the first inner lateral surface, and farther away from the first plastic lens element than the first inner lateral surface from the first plastic lens element. The frame element is fixed to the plastic lens barrel, and includes a second inner lateral surface. The second inner lateral surface surrounds the optical axis and faces towards the first outer lateral surface, and the second inner lateral surface is physically contacted with a second area of the first outer lateral surface. The gap is formed between the first outer lateral surface and the second inner lateral surface, the gap extends along the optical axis from the second area, and the gap corresponds to the first area. The imaging lens assembly further includes at least one annular structure which is disposed on the first inner lateral surface, the at least one annular structure corresponds to the gap, and the at least one annular structure surrounds the optical axis and extends in a direction away from the gap. On a cross-section parallel to the optical axis, a width of the gap corresponding to the at least one annular structure is narrower than a width of the gap corresponding to the first area, and a minimum width of the gap corresponding to the at least one annular structure is WN, the following condition is satisfied: 0.004 mm≤WN≤0.05 mm.

### BRIEF DESCRIPTION OF THE DRAWINGS

The present disclosure can be more fully understood by reading the following detailed description of the embodiment, with reference made to the accompanying drawings as follows:

FIG. 1A is a schematic view of a camera module according to the 1st Embodiment of the present disclosure.

FIG. 1B is an exploded view of the camera module according to the 1st Example in FIG. 1A.

FIG. 1C is a cross-sectional view of the camera module according to the 1st Example in FIG. 1A.

FIG. 1D is a cross-sectional view of the imaging lens assembly according to the 1st Example of the present disclosure.

FIG. 1E is an enlarged view of zone 1E of the camera module according to the 1st Example in FIG. 1C.

FIG. 1F is an enlarged view of zone 1F of the camera module according to the 1st Example in FIG. 1C.

FIG. 1G is an enlarged view of zone 1G in FIG. 1F.

FIG. 2A is a schematic view of a camera module according to the 2nd Embodiment of the present disclosure.

FIG. 2B is an exploded view of the camera module according to the 2nd Example in FIG. 2A.

FIG. 2C is a cross-sectional view of the camera module according to the 2nd Example in FIG. 2A.

FIG. 2D is a cross-sectional view of the imaging lens assembly according to the 2nd Example of the present disclosure.

FIG. 2E is an enlarged view of zone 2E of the camera module according to the 2nd Example in FIG. 2C.

FIG. 2F is an enlarged view of zone 2F of the camera module according to the 2nd Example in FIG. 2C.

FIG. 3A is a schematic view of a camera module according to the 3rd Embodiment of the present disclosure.

FIG. 3B is an exploded view of the camera module according to the 3rd Example in FIG. 3A.

FIG. 3C is a cross-sectional view of the camera module according to the 3rd Example in FIG. 3A.

FIG. 3D is a cross-sectional view of the imaging lens assembly according to the 3rd Example of the present disclosure.

FIG. 3E is an enlarged view of zone 3E of the camera module according to the 3rd Example in FIG. 3C.

FIG. 4A is a schematic view of a camera module according to the 4th Embodiment of the present disclosure.

FIG. 4B is an exploded view of the camera module according to the 4th Example in FIG. 4A.

FIG. 4C is a cross-sectional view of the camera module according to the 4th Example in FIG. 4A.

FIG. 4D is a cross-sectional view of the imaging lens assembly according to the 4th Example of the present disclosure.

FIG. 4E is an enlarged view of zone 4E of the camera module according to the 4th Example in FIG. 4C.

FIG. 4F is an enlarged view of zone 4F of the camera module according to the 4th Example in FIG. 4C.

FIG. 5A is a schematic view of an electronic device according to the 5th Embodiment of the present disclosure.

FIG. 5B is another schematic view of the electronic device according to the 5th Embodiment in FIG. 5A.

FIG. 6 is a schematic view of an electronic device applied to a drone according to the 6th Embodiment of the present disclosure.

FIG. 7 is a schematic view of an electronic device applied to a vehicle according to the 7th Embodiment of the present disclosure.

### DETAILED DESCRIPTION

The present disclosure provides an imaging lens assembly that includes a plurality of lens elements, a plastic lens barrel, a frame element and a gap, wherein the lens elements are arranged in order along an optical axis, and the frame element is fixed to the plastic lens barrel. The lens elements include a glass lens element and a first plastic lens element, the first plastic lens element is disposed corresponding to the glass lens element, and the first plastic lens element is disposed in the plastic lens barrel. The plastic lens barrel includes a first inner lateral surface and a first outer lateral surface, the first inner lateral surface surrounds the optical axis, the first plastic lens element is physically contacted with a first area of the first inner lateral surface, the first outer lateral surface is disposed corresponding to the first inner lateral surface, and farther away from the first plastic lens element than the first inner lateral surface from the first plastic lens element. The frame element includes a second inner lateral surface which surrounds the optical axis and faces towards the first outer lateral surface, the second inner lateral surface is physically contacted with a second area of the first outer lateral surface. The gap is formed between the first outer lateral surface and the second inner lateral surface, the gap extends along the optical axis from the second area, and the gap corresponds to the first area. The imaging lens assembly further includes at least one first annular structure which is disposed on the first inner lateral surface, the first annular structure corresponds to the second area, and the first annular structure surrounds the optical axis and extends in a direction away from the frame element. The imaging lens assembly can simultaneously include the glass lens element and the first plastic lens element. Therefore, the optical quality can be improved and the impact of the environment on the imaging lens assembly can be reduced. The first plastic lens element is physically contacted with the plastic lens barrel at the first area which corresponds to the gap. Therefore, a margin for the first plastic lens element expanding in a direction perpendicular to the optical axis is provided so as to guide the deformation direction of the first plastic lens element. Moreover, the first annular structure corresponds to the second area so that the mechanical strength of the second area can be enhanced. Therefore, the impact of the environment on the size of the imaging lens assembly can be reduced.

Specifically, the frame element can be a socket, a frame, a base or a lens retainer, but the present disclosure is not limited thereto. Further, the frame element is fixed to the plastic lens barrel by screw fitting, glue dispensing, mechanical fitting or combining multiple methods, but the present disclosure is not limited thereto.

The imaging lens assembly can further include a first annular element which forms the first annular structure, the first annular element can be physically contacted with a third area of the first inner lateral surface. Therefore, the assembling flexibility can be improved.

A hardness of the first annular element can be greater than a hardness of the plastic lens barrel. Therefore, the axial deformation resistance of the plastic lens barrel can be improved so as to enhance the impact resistance of the imaging lens assembly. Specifically, the first annular element can be a metal element, a ceramic element or a plastic element with glass fibers, but the present disclosure is not limited thereto.

The first inner lateral surface and the first annular structure can be formed integrally. Therefore, the element usage can be reduced to simplify the assembling process.

The frame element can include an extending structure, the extending structure extends in a direction close to the optical axis, and one of the lens elements relies on the extending structure. Therefore, a function for retaining the lens elements of the frame element can be further obtained so as to reduce the element usage.

A hardness of the frame element can be greater than the hardness of the plastic lens barrel. Therefore, the size of the plastic lens barrel can be maintained during environment changing so that the lifetime of the imaging lens assembly can be extended. Specifically, the frame element can be a metal element, a ceramic element or a plastic element with glass fibers, but the present disclosure is not limited thereto.

The second area may not overlap with the first area in a direction perpendicular to the optical axis. Therefore, the deforming margin of the first plastic lens element in the direction perpendicular to the optical axis can be ensured.

On a cross-section parallel to the optical axis, when the first plastic lens element defines a lens diameter as D, and a lens barrel thickness of the plastic lens barrel in the first area is T, the following condition can be satisfied: 0.018≤T/D≤0.6. Therefore, a deforming direction of the lens elements can be guided so as to maintain the distance between two of the lens elements. Moreover, on the cross-section parallel to the optical axis, when the first plastic lens element defines the lens diameter as D, and the lens barrel thickness of the plastic lens barrel in the first area is T, the following condition can be satisfied: 0.02≤T/D≤0.22.

On the cross-section parallel to the optical axis, when the lens barrel thickness of the plastic lens barrel in the first area is T, the following condition can be satisfied: 0.22 mm≤T≤3.0 mm. Therefore, a sufficient support can be provided to prevent the plastic lens element from squeezed during deformation.

On the cross-section parallel to the optical axis, when a minimum width of the gap corresponding to the first area is W, the following condition can be satisfied: 0.0012 mm≤W≤0.24 mm. Therefore, with a sufficient deforming margin, the mechanical stability can be enhanced to improve the yield rate.

The first annular structure is disposed in a third area of the first inner lateral surface, on a cross-section parallel to the optical axis, when an overlapping length of the third area and the second area is O, and a length of the plastic lens barrel is PBL, the following condition can be satisfied: 0.012≤O/PBL≤0.42. Therefore, it is favorable for preventing the frame element from separating during the plastic element deforming so that the lifetime of the imaging lens assembly can be extended.

A number of the first annular structure can be plural. Therefore, it is favorable for ensuring the optical quality by further maintaining the distance between two of the lens elements.

The imaging lens assembly can further include a retaining element which retains the plastic lens barrel and the frame element, the retaining element is disposed in the frame element, and the retaining element is physically contacted with at least one of the lens elements and the plastic lens barrel. Therefore, the retaining stability between the frame element and the plastic lens barrel can be enhanced. Specifically, the retaining element can be a covering element, an adhering glue or a combination of multiple elements, or the retaining element can be a retaining glue formed by melting some elements via temperature or chemical method, but the present disclosure is not limited thereto.

The lens elements can further include a second plastic lens element, and the first annular structure is disposed between the second plastic lens element and the first plastic lens element. The second plastic lens element can be physically contacted with the first inner lateral surface, and the second plastic lens element can correspond to the gap. Therefore, the first annular structure can obtain a function of further maintaining the distance between two of the lens elements so as to enhance the optical performance.

The first annular structure can be disposed adjacent to the first plastic lens element. Therefore, the matching relationship between the first plastic lens element and the first annular structure can be further maintained to improve the assembling efficiency.

The imaging lens assembly can further include a second annular structure which is disposed on the first inner lateral surface and corresponds to the gap in the direction perpendicular to the optical axis, and the second annular structure surrounds the optical axis and extends in a direction away from the gap. On a cross-section parallel to the optical axis, a width of the gap corresponding to the second annular structure can be narrower than a width of the gap corresponding to the first area, when a minimum width of the gap corresponding to the second annular structure is WN, the following condition is satisfied: 0.004 mm≤WN≤0.05 mm. The gap corresponding to the second annular structure is narrower so that the expanding margin of the lens elements can be maintained and the mechanical strength of the imaging lens assembly can be simultaneously improved. Therefore, it is favorable for enhancing the stability of the entire optical system. Furthermore, when the minimum width of the gap corresponding to the second annular structure is WN, the following condition is satisfied: 0.005 mm≤WN≤0.04 mm.

The imaging lens assembly can further include a protruding structure which is disposed on the first outer lateral surface of the plastic lens barrel and corresponds to the second annular structure, the protruding structure protrudes in a direction away from the second annular structure, and the protruding structure maintains the gap with the frame element. Therefore, it is favorable for controlling the deformation of the plastic lens barrel by enhancing the mechanical strength of the third area.

The protruding structure can include a plurality of sub-protruding structures, and the sub-protruding structures are arranged at intervals. The circulation of gaps on two sides of the protruding structure can be maintained after deformation. Therefore, the deforming margin of the first plastic lens element can be further maintained.

Each of the aforementioned features of the imaging lens assembly can be utilized in various combinations for achieving the corresponding effects.

The present disclosure provides a camera module which includes the aforementioned imaging lens assembly and an element carrier, wherein the frame element of the imaging lens assembly is fixed in the element carrier. Therefore, it is favorable for avoiding the deformation of the plastic lens barrel during the assembling process so as to improve the assembling yield rate. Specifically, a function for driving the imaging lens assembly of the element carrier can be further obtained to achieve the auto-focusing and the optical image stabilization, but the present disclosure is not limited thereto.

The present disclosure provides an electronic device that includes the aforementioned camera module.

The present disclosure provides an imaging lens assembly that includes a plurality of lens elements, a plastic lens barrel, a frame element and a gap, wherein the lens elements are arranged in order along an optical axis, and the frame element is fixed to the plastic lens barrel. The lens elements include a glass lens element and a first plastic lens element, the first plastic lens element is disposed corresponding to the glass lens element, and the first plastic lens element is disposed in the plastic lens barrel. The plastic lens barrel includes a first inner lateral surface and a first outer lateral surface, the first inner lateral surface surrounds the optical axis, the first plastic lens element is physically contacted with a first area of the first inner lateral surface, the first outer lateral surface is disposed corresponding to the first inner lateral surface, and farther away from the first plastic lens element than the first inner lateral surface from the first plastic lens element. The frame element includes a second inner lateral surface which surrounds the optical axis and faces towards the first outer lateral surface, and the second inner lateral surface is physically contacted with a second area of the first outer lateral surface. The gap is formed between the first outer lateral surface and the second inner lateral surface, the gap extends along the optical axis from the second area, and the gap corresponds to the first area. The imaging lens assembly further includes at least one annular structure, which is disposed on the first inner lateral surface, the annular structure corresponds to the gap, and the annular structure surrounds the optical axis and extends in a direction away from the gap. On a cross-section parallel to the optical axis, a width of the gap corresponding to the annular structure is narrower than a width of the gap corresponding to the first area, when a minimum width of the gap corresponding to the annular structure is WN, the following condition is satisfied: 0.004 mm≤WN≤0.05 mm. Therefore, the imaging lens assembly can simultaneously include the glass lens element and the first plastic lens element so that the optical quality can be improved and the impact of the environment on the imaging lens assembly can be reduced. Moreover, the first plastic lens element is physically contacted with the plastic lens barrel at the first area which corresponds to the gap. Therefore, a margin for the first plastic lens element expanding in a direction perpendicular to the optical axis is provided so as to guide the deformation direction of the first plastic lens element. Further, the width of the gap corresponding to the annular structure is narrower than the width of the gap corresponding to the first area so that when the plastic lens barrel is squeezed by the frame element, the first plastic lens element is prevented from being affected so as to maintain the optical quality. Specifically, the frame element can be a socket, a frame, a base or a lens retainer, but the present disclosure is not limited thereto.

The imaging lens assembly can further include a protruding structure which is disposed on the first outer lateral surface of the plastic lens barrel and corresponds to the annular structure, the protruding structure protrudes in a direction away from the annular structure, and the protruding structure maintains the gap with the frame element. Therefore, it is favorable for controlling the deformation of the plastic lens barrel by enhancing the mechanical strength.

The protruding structure can include a plurality of sub-protruding structures, and the sub-protruding structures are arranged at intervals. The circulation of gaps on two sides of the protruding structure can be maintained after deformation. Therefore, the deforming margin of the first plastic lens element can be further maintained.

On the cross-section parallel to the optical axis, when a minimum width of the gap corresponding to the first area is W, the following condition can be satisfied: 0.0012 mm≤W≤0.24 mm. Therefore, with a sufficient deforming margin, the mechanical stability can be enhanced to improve the yield rate.

The second area may not overlap with the first area in a direction parallel to the optical axis. Therefore, the deforming margin of the first plastic lens element in the direction perpendicular to the optical axis can be ensured.

On a cross-section parallel to the optical axis, when the first plastic lens element defines a lens diameter as D, and a lens barrel thickness of the plastic lens barrel in the first area is T, the following condition can be satisfied: 0.018≤T/D≤0.6. Therefore, a deforming direction of the lens elements can be guided so as to maintain the distance between two of the lens elements.

A number of the annular structure can be plural. Therefore, it is favorable for ensuring the optical quality by further maintaining the distance between two of the lens elements.

The lens elements can further include a second plastic lens element, the annular structure is disposed between the first plastic lens element and the second plastic lens element. The second plastic lens element is physically contacted with the first inner lateral surface, and the second plastic lens element corresponds to the gap. Therefore, a function for further maintaining the distance between two of the lens elements of the annular structure is obtained to enhance the optical performance.

The annular structure can be disposed adjacent to the first plastic lens element. Therefore, the matching relationship between the first plastic lens element and the annular structure can be further maintained to improve the assembling efficiency.

Each of the aforementioned features of the imaging lens assembly can be utilized in various combinations for achieving the corresponding effects.

According to the aforementioned embodiment, specific examples are provided, and illustrated via figures.

### 1st Embodiment

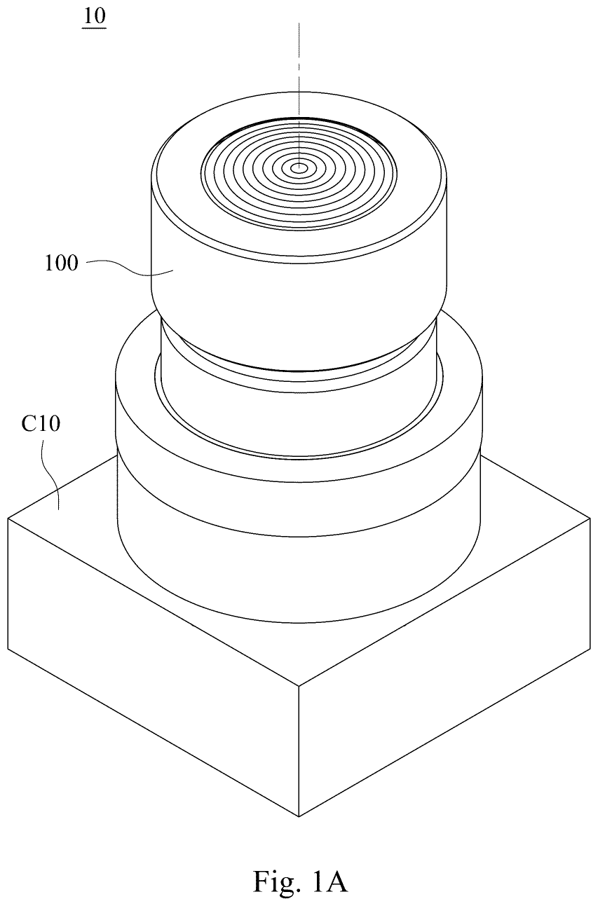

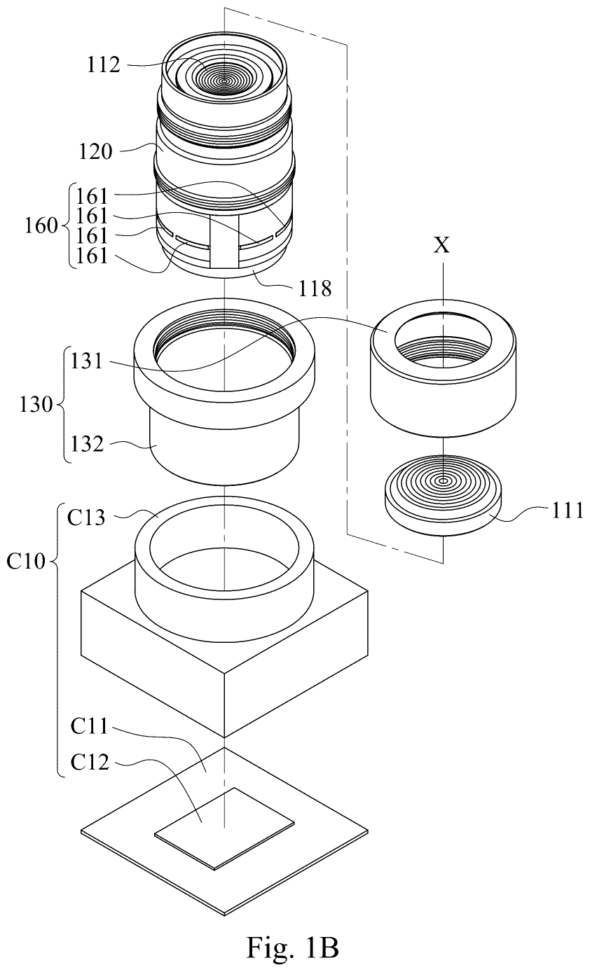

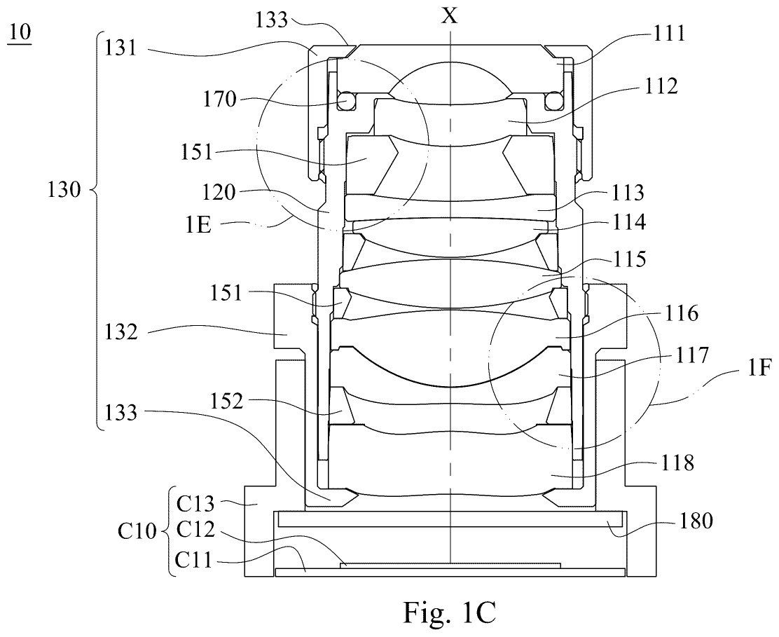

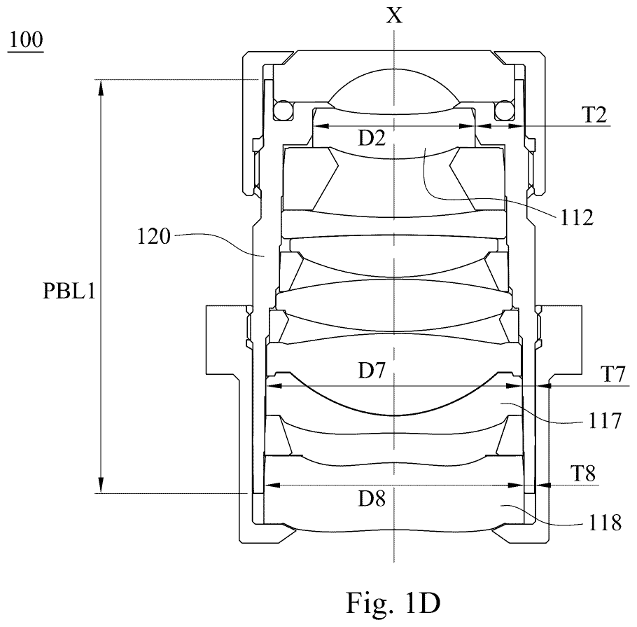

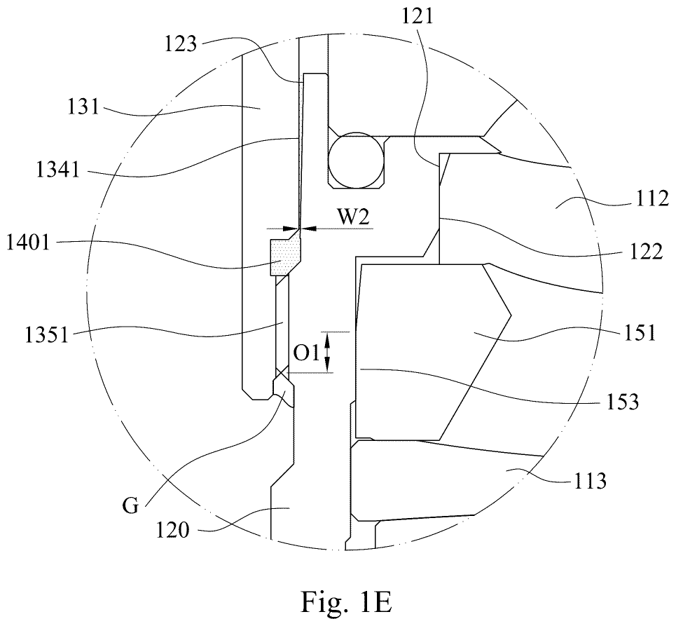

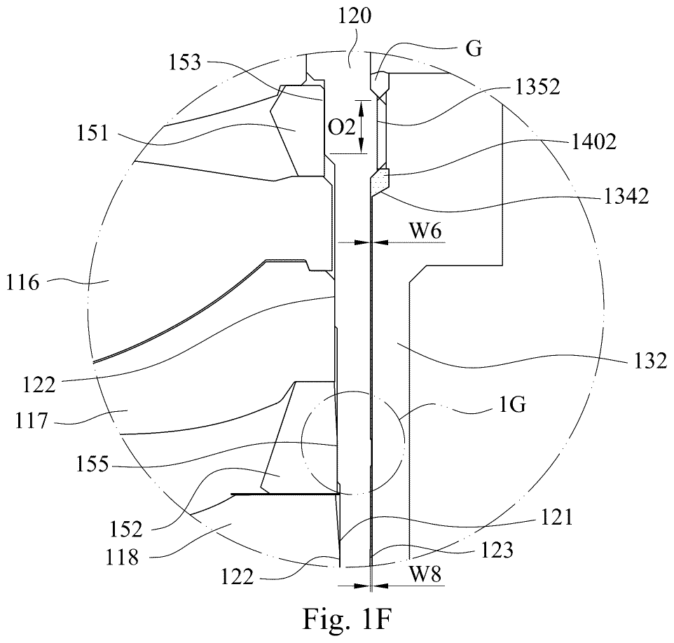

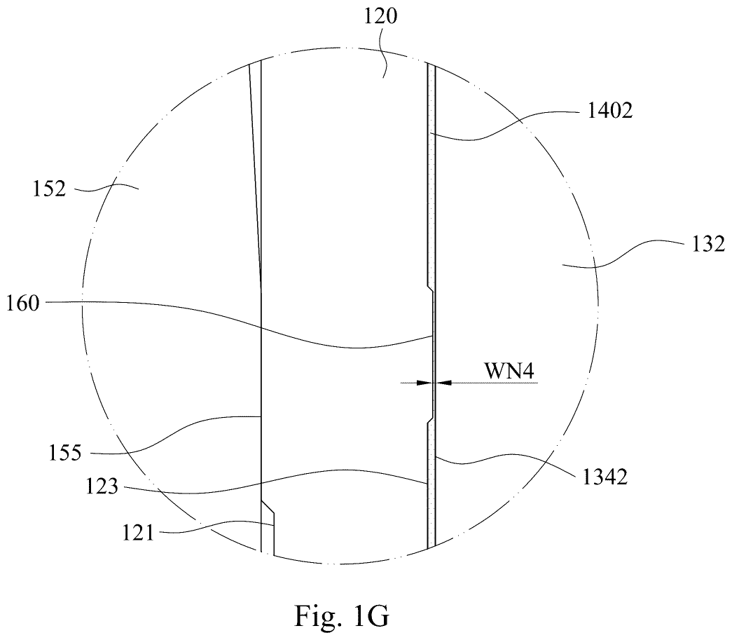

FIG. 1A is a schematic view of a camera module 10 according to the 1st Embodiment of the present disclosure. In FIG. 1A, the camera module 10 includes an imaging lens assembly 100 and an element carrier C10.

FIG. 1B is an exploded view of the camera module 10 according to the 1st Example in FIG. 1A, FIG. 1C is a cross-sectional view of the camera module 10 according to the 1st Example in FIG. 1A, and FIG. 1D is a cross-sectional view of the imaging lens assembly 100 according to the 1st Example of the present disclosure. In FIG. 1B to FIG. 1D, the imaging lens assembly 100 includes a plurality of lens elements, a plastic lens barrel 120, a frame element 130 and a first annular structure (its reference numeral is omitted), wherein a first annular element 151 forms the first annular structure. The lens elements are, arranged in order along an optical axis X, a first lens element 111, a second lens element 112, a third lens element 113, a fourth lens element 114, a fifth lens element 115, a sixth lens element 116, a seventh lens element 117 and a eighth lens element 118. The frame element 130 is fixed to the plastic lens barrel 120, and the frame element 130 can include a first frame element 131 and a second frame element 132. Moreover, the imaging lens assembly 100 can further include a second annular structure (its reference numeral is omitted), wherein a second annular element 152 forms the second annular structure. Further, a hardness of the first frame element 131 and a hardness of the second frame element 132 can be respectively greater than a hardness of the plastic lens barrel 120, and a hardness of the first annular element 151 can be greater than the hardness of the plastic lens barrel 120.

In detail, the element carrier C10 can include an electronic element carrier C11, an image sensor C12 and a base C13, and the second frame element 132 of the imaging lens assembly 100 is fixed in the element carrier C10.

Moreover, the imaging lens assembly 100 can further include a protruding structure 160 which is disposed on the plastic lens barrel 120, wherein the protruding structure 160 can include a plurality of sub-protruding structures 161, and the sub-protruding structures 161 are arranged at intervals.

Specifically, the first lens element 111, the third lens element 113, the fourth lens element 114 and the fifth lens element 115 are glass lens elements. The second lens element 112, the sixth lens element 116, the seventh lens element 117 and the eighth lens element 118 are plastic lens elements. The plastic lens elements are disposed corresponding to the glass lens elements, that is, the first lens element 111 and the third lens element 113 are respectively disposed corresponding to the second lens element 112, the fifth lens element 115 is disposed corresponding to the sixth lens element 116. Further, the plastic lens elements (i.e. the second lens element 112, the sixth lens element 116, the seventh lens element 117 and the eighth lens element 118) are disposed in the plastic lens barrel 120.

Moreover, the frame element 130 can include two extending structures 133, one of the extending structures 133 is disposed on the first frame element 131, and the other of the extending structures 133 is disposed on the second frame element 132. The extending structures 133 extend in a direction close to the optical axis X, wherein at least one of the lens elements of the imaging lens assembly 100 relies on one of the extending structures 133. Specifically, the extending structure 133 of the first frame element 131 is configured to position the first lens element 111, and the extending structure 133 of the second frame element 132 is configured to position the eighth lens element 118.

Furthermore, the camera module 10 can further include a sealing element 170, and the sealing element 170 is disposed between the first lens element 111 and the plastic lens barrel 120. Further, the camera module 10 can further include a filter 180, and the filter 180 is disposed on an image side of the imaging lens assembly 100.

FIG. 1E is an enlarged view of zone 1E of the camera module 10 according to the 1st Example in FIG. 1C, FIG. 1F is an enlarged view of zone 1F of the camera module 10 according to the 1st Example in FIG. 1C, and FIG. 1G is an enlarged view of zone 1G in FIG. 1F. In FIG. 1C, FIG. 1E and FIG. 1F, the plastic lens barrel 120 includes a first inner lateral surface 121 and a first outer lateral surface 123, the first inner lateral surface 121 surrounds the optical axis X, and the second lens element 112, the seventh lens element 117 and the eighth lens element 118 are respectively physically contacted with first areas 122 of the first inner lateral surface 121 corresponding to the second lens element 112, the seventh lens element 117 and the eighth lens element 118. The first outer lateral surface 123 is disposed corresponding to the first inner lateral surface 121, and farther away from the plastic lens elements than the first inner lateral surface 121 from the plastic lens elements.

The first frame element 131 and the second frame element 132 of the frame element 130 respectively include second inner lateral surfaces 1341, 1342, which surround the optical axis X and respectively face towards the first outer lateral surface 123, and the second inner lateral surfaces 1341, 1342 are respectively physically contacted with second areas 1351, 1352 of the first outer lateral surface 123.

The imaging lens assembly 100 includes a gap 1401, the gap 1401 is formed between the first outer lateral surface 123 and the second inner lateral surface 1341, the gap 1401 extends along the optical axis X from the second area 1351 corresponding to the gap 1401, and the gap 1401 corresponds to the first area 122 corresponding to the gap 1401. A gap 1402 is formed between the first outer lateral surface 123 and the second inner lateral surface 1342, the gap 1402 extends along the optical axis X from the second area 1352 corresponding to the gap 1402, and the gap 1402 corresponds to the first area 122 corresponding to the gap 1402. Moreover, the second area 1351 may not overlap with the first area 122 in a direction perpendicular to the optical axis X, and the second area 1352 may not overlap with the first area 122 in the direction perpendicular to the optical axis X.

The imaging lens assembly 100 can further include a first annular element 151 forming the first annular structure. The first annular structure is disposed on the first inner lateral surface 121, the first annular structure corresponds to the second areas 1351, 1352 corresponding to the first annular structure, and the first annular structure surrounds the optical axis X and extends in a direction away from the first frame element 131 and the second frame element 132, respectively.

The first annular elements 151 can be physically contacted with a third area 153 of the first inner lateral surface 121, and the first inner lateral surface 121 and the first annular structure formed by the first annular elements 151 can be formed integrally. Moreover, the first annular structure is disposed in the third areas 153 of the first inner lateral surface 121. Further, a number of the first annular structure can be plural, and the first annular structure can be disposed adjacent to at least one of the plastic lens elements.

The imaging lens assembly 100 can further include the second annular element 152 forming the second annular structure. The second annular structure is disposed on the first inner lateral surface 121, the second annular structure corresponds to the gap 1402, the second annular structure surrounds the optical axis X and extends in a direction away from the gap 1402. On a cross-section parallel to the optical axis X, a width of the gap 1402 corresponding to the second annular structure can be narrower than a width of the gap 1402 corresponding to the first area 122.

Specifically, the second annular structure is physically contacted with a sub-third area 155 of the first inner lateral surface 121, wherein a difference between the third area 153 and the sub-third area 155 is that the third area 153 corresponds to the second area 1325, and the sub-third area 155 corresponds to the gap 1402.

In FIG. 1E and FIG. 1F, the second inner lateral surfaces 1341, 1342 can include threads so that the second area 1351 of the plastic lens barrel 120 is physically contacted with the first frame element 131, and the second area 1352 is physically contacted with the second frame element 132. Specifically, the imaging lens assembly 100 can further include retaining elements (its reference numeral is omitted), the retaining elements can be two glues G that are respectively disposed in the second areas 1351, 1352. The retaining elements are configured to position the plastic lens barrel 120 and the first frame element 131, and to position the plastic lens barrel 120 and the second frame element 132.

In FIG. 1G, the protruding structure 160 is disposed on the first outer lateral surface 123 of the plastic lens barrel 120 and corresponds to the second annular structure, the protruding structure 160 protrudes in a direction away from the second annular structure, and the protruding structure 160 maintains the gap 1402 with the second frame element 132.

Specifically, the first frame element 131 and the second frame element 132 can be made of aluminum alloy, the plastic lens barrel 120 can be made of plastic, and the first annular elements 151 and the second annular element 152 can be made of plastic with glass fibers.

In FIG. 1D to FIG. 1G, on a cross-section parallel to the optical axis X, the second lens element 112 defines a lens diameter as D2, the seventh lens element 117 defines a lens diameter as D7, the eighth lens element 118 defines a lens diameter as D8, a lens barrel thickness of the plastic lens barrel 120 in the first area 122 corresponding to the second lens element 112 is T2, a lens barrel thickness of the plastic lens barrel 120 in the first area 122 corresponding to the seventh lens element 117 is T7, a lens barrel thickness of the plastic lens barrel 120 in the first area 122 corresponding to the eighth lens element 118 is T8, a minimum width of the gap 1401 corresponding to the first area 122 by the second lens element 112 is W2, a minimum width of the gap 1402 corresponding to the first area 122 by the sixth lens element 116 is W6, a minimum width of the gap 1402 corresponding to the first area 122 by the eighth lens element 118 is W8, a minimum width of the gap 1402 corresponding to the second annular structure is WN4. Moreover, in a direction parallel to the optical axis X, an overlapping length of the third area 153 between the second lens element 112 and the third lens element 113 and the second area 1351 is O1, an overlapping length of the third area 153 between the sixth lens element 116 and the fifth lens element 115 and the second area 1352 is O2, a length of the plastic lens barrel 120 is PBL1, and the aforementioned parameters satisfy the following conditions in Table 1.

TABLE 1
1st Embodiment

| | | | |
|---|---|---|---|
| D2 (mm) | 8.86 | T2/D2 | 0.30 |
| D7 (mm) | 14.0 | T7/D7 | 0.05 |
| D8 (mm) | 14.2 | T8/D8 | 0.04 |
| T2 (mm) | 2.69 | O1/PBL1 | 0.035 |
| T7 (mm) | 0.7 | O2/PBL1 | 0.046 |
| T8 (mm) | 0.58 | O1 (mm) | 0.79 |
| W2 (mm) | 0.02 | O2 (mm) | 1.03 |
| W6 (mm) | 0.03 | PBL1 (mm) | 22.56 |
| W8 (mm) | 0.038 | WN4 (mm) | 0.01 |

It should be noted that T2, T7 and T8 defined in the 1st Embodiment can be regarded as T defined in the present disclosure, D2, D7 and D8 defined in the 1st Embodiment can be regarded as D defined in the present disclosure, W2, W6 and W8 defined in the 1st Embodiment can be regarded as W defined in the present disclosure, O1 and O2 defined in the 1st Embodiment can be regarded as O defined in the present disclosure, PBL1 defined in the 1st Embodiment can be regarded as PBL defined in the present disclosure, and WN4 defined in the 1st Embodiment can be regarded as WN defined in the present disclosure.

### 2nd Embodiment

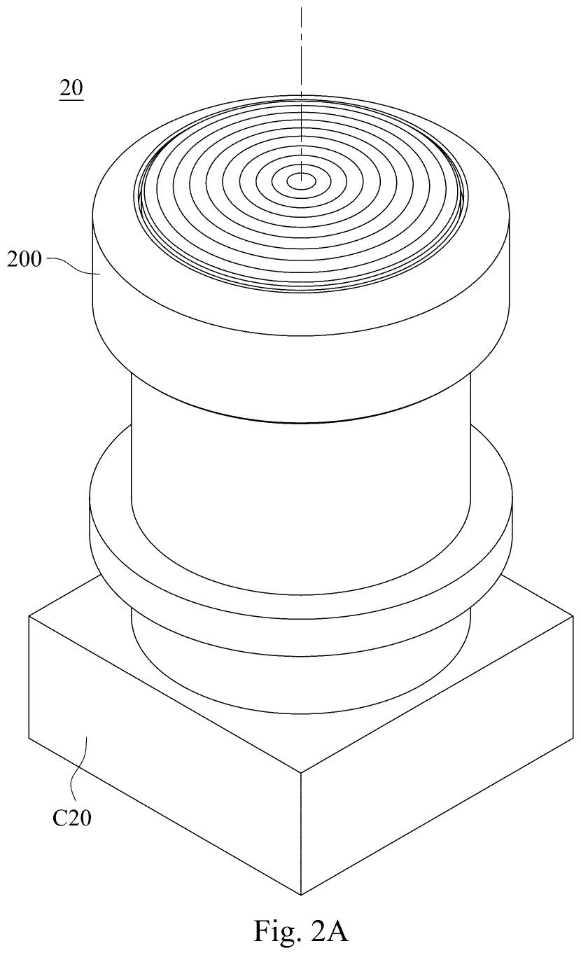

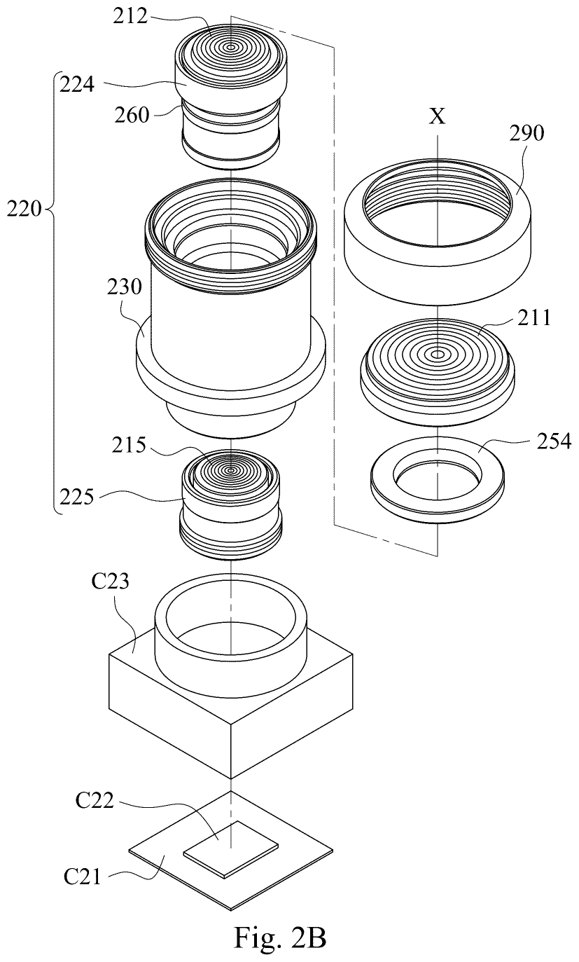

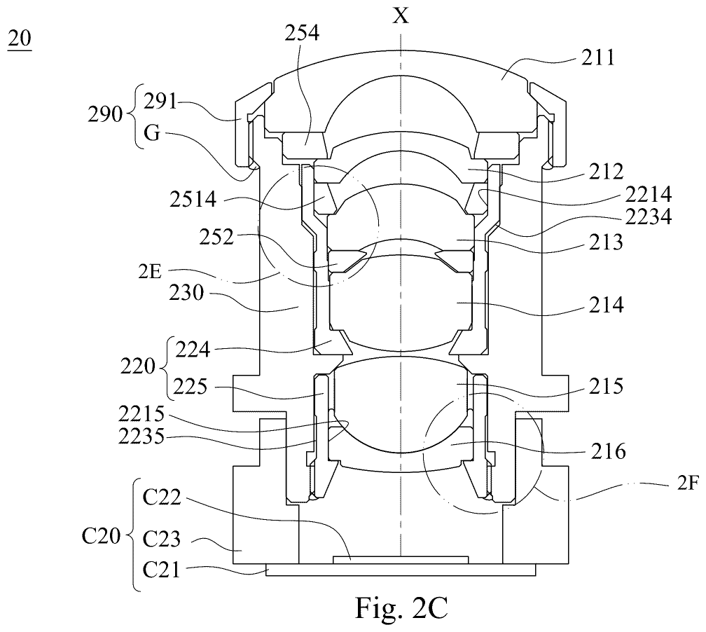

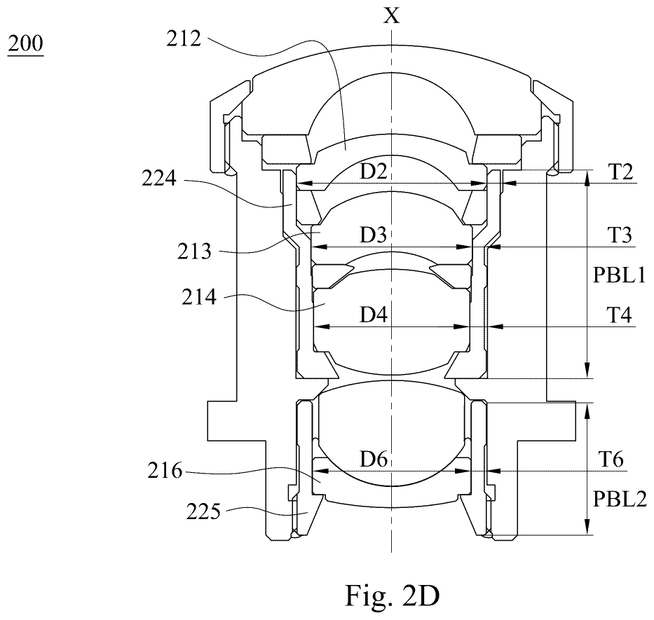

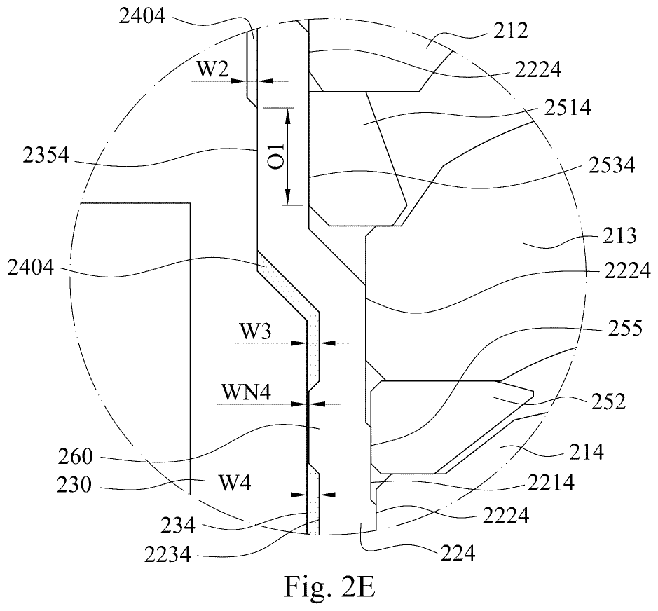

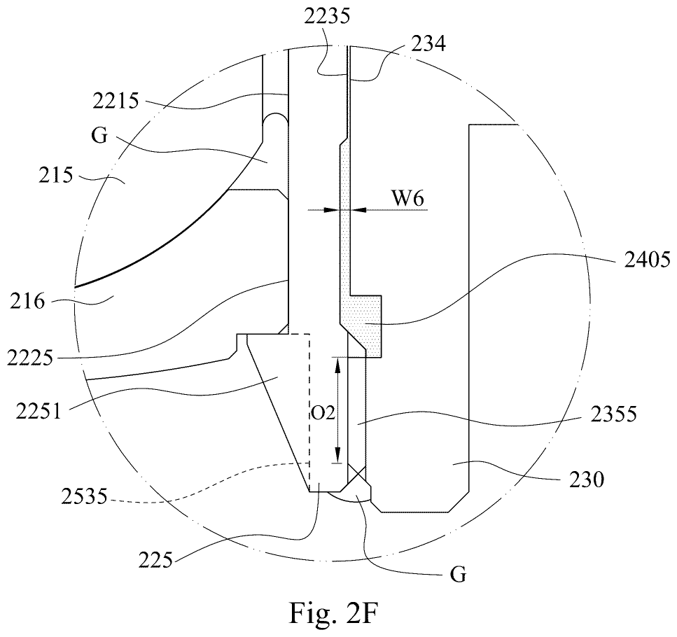

FIG. 2A is a schematic view of a camera module 20 according to the 2nd Embodiment of the present disclosure. In FIG. 2A, the camera module 20 includes an imaging lens assembly 200 and an element carrier C20.

FIG. 2B is an exploded view of the camera module 20 according to the 2nd Example in FIG. 2A, FIG. 2C is a cross-sectional view of the camera module 20 according to the 2nd Example in FIG. 2A, and FIG. 2D is a cross-sectional view of the imaging lens assembly 200 according to the 2nd Example of the present disclosure. In FIG. 2B to FIG. 2D, the imaging lens assembly 200 includes a plurality of lens elements, a plastic lens barrel 220, a frame element 230 and a first annular structure (its reference numeral is omitted). The lens elements are, arranged in order along an optical axis X, a first lens element 211, a second lens element 212, a third lens element 213, a fourth lens element 214, a fifth lens element 215 and a sixth lens element 216, wherein The imaging lens assembly 200 can include a first plastic lens element and a second plastic lens element, and the first annular structure is disposed between the second plastic lens element and the first plastic lens element. The plastic lens barrel 220 can include a first plastic lens barrel 224 and a second plastic lens barrel 225. The imaging lens assembly 200 can further include a first annular element 2514 which forms the first annular structure. Moreover, the imaging lens assembly 200 can further include a second annular structure (its reference numeral is omitted), wherein a second annular element 252 which forms the second annular structure. Further, a hardness of the frame element 230 can be greater than a hardness of the plastic lens barrel 220, and a hardness of the first annular element 2514 can be greater than the hardness of the plastic lens barrel 220.

In detail, the element carrier C20 can include an electronic element carrier C21, an image sensor C22 and a base C23, and the frame element 230 of the imaging lens assembly 200 is fixed in the element carrier C20.

Moreover, the imaging lens assembly 200 can further include a protruding structure 260 which is disposed on the first plastic lens barrel 224.

Specifically, the first lens element 211 is a glass lens element, the second lens element 212, the third lens element 213, the fourth lens element 214, the fifth lens element 215 and the sixth lens element 216 are plastic lens elements. The plastic lens elements are disposed corresponding to the glass lens element, that is, the first lens element 211 is disposed corresponding to the second lens element 212. The plastic lens elements (i.e. the second lens element 212, the third lens element 213, the fourth lens element 214, the fifth lens element 215 and the sixth lens element 216) are disposed in the plastic lens barrel 220. Moreover, the imaging lens assembly 200 can further include a third annular element 254 between the first lens element 211 and the second lens element 212 so as to position the first lens element 211 and the second lens element 212.

Furthermore, the imaging lens assembly 200 can further include a retaining element 290 to retain the plastic lens barrel 220 and the frame element 230, the retaining element 290 is disposed on the frame element 230, and is physically contacted with at least one of the lens elements and the plastic lens barrel 220. Further, the retaining element 290 can include a covering element 291 and a glue G to position the first lens element 211.

FIG. 2E is an enlarged view of zone 2E of the camera module 20 according to the 2nd Example in FIG. 2C, and FIG. 2F is an enlarged view of zone 2F of the camera module 20 according to the 2nd Example in FIG. 2C. In FIG. 2C, FIG. 2E and FIG. 2F, the first plastic lens barrel 224 includes a first inner lateral surface 2214 and a first outer lateral surface 2234, the second plastic lens barrel 225 includes a first inner lateral surface 2215 and a first outer lateral surface 2235, the first inner lateral surface 2214 of the first plastic lens barrel 224 surrounds the optical axis X, and the first inner lateral surface 2215 of the second plastic lens barrel 225 surrounds the optical axis X. Moreover, the second lens element 212, the third lens element 213, the fourth lens element 214 and the sixth lens element 216 are respectively physically contacted with the first area 2224 of the first inner lateral surface 2214 and the first area 2225 of the first inner lateral surface 2215 corresponding to the second lens element 212, the third lens element 213, the fourth lens element 214 and the sixth lens element 216. The first outer lateral surface 2234 is disposed corresponding to the first inner lateral surface 2214, and farther away from the plastic lens elements physically contacted with the first inner lateral surface 2214 than the first inner lateral surface 2214 from the plastic lens elements physically contacted with the first inner lateral surface 2214. The first outer lateral surface 2235 is disposed corresponding to the first inner lateral surface 2215, and farther away from the plastic lens elements physically contacted with the first inner lateral surface 2215 than the first inner lateral surface 2215 from the plastic lens elements physically contacted with the first inner lateral surface 2215. The frame element 230 includes a second inner lateral surface 234, the second inner lateral surface 234 surrounds the optical axis X and faces towards the first outer lateral surfaces 2234, 2235, and the second inner lateral surface 234 is respectively physically contacted with one of a second area 2354 of the first outer lateral surface 2234 and a second area 2355 of the first outer lateral surface 2235. Specifically, the frame element 230 is physically contacted with the second area 2354 of the first plastic lens barrel 224 and the second area 2355 of the second plastic lens barrel 225, wherein the first plastic lens barrel 224 and the second plastic lens barrel 225 respectively match the size of the frame element 230 to achieve the physical contact.

The imaging lens assembly 200 includes gaps 2404, 2405. The gap 2404 is formed between the first outer lateral surface 2234 and the second inner lateral surface 234, the gap 2404 extends along the optical axis X from the second area 2354, and the gap 2404 corresponds to the first area 2224 corresponding to the gap 2404. The gap 2405 is formed between the first outer lateral surface 2235 and the second inner lateral surface 234, the gap 2405 extends along the optical axis X from the second area 2355, and the gap 2405 overlaps with the first area 2225 corresponding to the gap 2405 in a direction perpendicular to the optical axis X. Moreover, the second area 2354 may not overlap with the first area 2224 in a direction perpendicular to the optical axis X, and the second area 2355 may not overlap with the first area 2225 in a direction perpendicular to the optical axis X.

Further, the second lens element 212, the third lens element 213 and the fourth lens element 214 correspond to the gap 2404, and the sixth lens element 216 corresponds to the gap 2405.

The imaging lens assembly 200 can further include a first annular element 2514 which forms the first annular structure. The first annular structure is disposed on the first inner lateral surfaces 2214, 2215, the first annular structure overlaps with the second areas 2354, 2355, and the first annular structure surrounds the optical axis X and extends in a direction away from the frame element 230.

Furthermore, the first annular structure formed by the first annular elements 2514 can be physically contacted with a third area 2534 of the first inner lateral surface 2214, and the first inner lateral surface 2214 and the first annular structure can be formed integrally. Moreover, the first annular structure is disposed in the third area 2534 of the first inner lateral surface 2214. Further, the first annular structure can be disposed adjacent to at least one of the plastic lens elements.

The imaging lens assembly 200 can further include a second annular element 252 which forms the second annular structure. The second annular structure formed by the second annular element 252 is disposed on the first inner lateral surface 2214, the second annular structure corresponds to the gap 2404, the second annular structure surrounds the optical axis X and extends in a direction away from the gap 2404. On a cross-section parallel to the optical axis X, a width of the gap 2404 corresponding to the second annular structure can be narrower than a width of the gap 2404 corresponding to the first area 2224.

Specifically, the second annular structure is physically contacted with a sub-third area 255 of the first inner lateral surface 2214.

In FIG. 2C, FIG. 2E and FIG. 2F, the second inner lateral surface 234 can include threads so that the second area 2354 of the first plastic lens barrel 224 is physically contacted with the frame element 230, and the second area 2355 of the second plastic lens barrel 225 is physically contacted with the frame element 230. Further, the imaging lens assembly 200 can further include two glues G, one of the glues G is disposed on the first inner lateral surface 2215 to position the fifth lens element 215 and the sixth lens element 216, the other of the glues G is disposed between the first outer lateral surface 2235 and the second inner lateral surface 234 to position the second plastic lens barrel 225 and the frame element 230.

In FIG. 2E, the protruding structure 260 is disposed on the first outer lateral surface 2234 of the first plastic lens barrel 224 and corresponds to the second annular structure formed by the second annular element 252, the protruding structure 260 protrudes in a direction away from the second annular structure, and the protruding structure 260 maintains the gap 2404 with the frame element 230.

Moreover, in FIG. 2F, a surface (i.e. the first inner lateral surface 2215) facing towards the optical axis X of the second plastic lens barrel 225 can include one another first annular structure 2251, the first annular structure 2251 surrounds the optical axis X and extends in a direction away from the frame element 230 so as to position the sixth lens element 216. Further, the first annular structure 2251 is disposed in a third area 2535 of the first inner lateral surface 2215.

Specifically, the frame element 230, the retaining element 290, the first annular elements 2514 and the second annular element 252 can be made of copper alloy, and the first plastic lens barrel 224 and the second plastic lens barrel 225 can be made of plastic.

In FIG. 2D to FIG. 2F, on a cross-section parallel to the optical axis X, the second lens element 212 defines a lens diameter as D2, the third lens element 213 defines a lens diameter as D3, the fourth lens element 114 defines a lens diameter as D4, the sixth lens element 116 defines a lens diameter as D6, a lens barrel thickness of the first plastic lens barrel 224 in the first area 2224 corresponding to the second lens element 212 is T2, a lens barrel thickness of the first plastic lens barrel 224 in the first area 2224 corresponding to the third lens element 213 is T3, a lens barrel thickness of the first plastic lens barrel 224 in the first area 2224 corresponding to the fourth lens element 214 is T4, a lens barrel thickness of the second plastic lens barrel 225 in the first area 2225 corresponding to the sixth lens element 216 is T6, a minimum width of the gap 2404 corresponding to the first area 2224 by the second lens element 212 is W2, a minimum width of the gap 2404 corresponding to the first area 2224 by the third lens element 213 is W3, a minimum width of the gap 2404 corresponding to the first area 2224 by the fourth lens element 214 is W4, a minimum width of the gap 2405 corresponding to the first area 2225 by the sixth lens element 216 is W6, and a minimum width of the gap 2404 corresponding to the second annular structure is WN4. Moreover, in a direction parallel to the optical axis, an overlapping length of the third area 2534 between the second lens element 212 and the third lens element 213 and the second area 2354 is O1, an overlapping length of the third area 2535 adjacent to the sixth lens element 216 and the second area 2355 is O2, a length of the first plastic lens barrel 224 is PBL1, a length of the second plastic lens barrel 225 is PBL2, and the aforementioned parameters satisfy the following conditions in Table 2.

TABLE 2
2nd Embodiment

| | | | |
|---|---|---|---|
| D2 (mm) | 7.2 | T2/D2 | 0.07 |
| D3 (mm) | 6.1 | T3/D3 | 0.07 |
| D4 (mm) | 5.9 | T4/D4 | 0.11 |
| D6 (mm) | 6.0 | T6/D6 | 0.08 |
| T2 (mm) | 0.5 | O1/PBL1 | 0.119 |
| T3 (mm) | 0.45 | O2/PBL2 | 0.206 |
| T4 (mm) | 0.65 | O1 (mm) | 0.94 |
| T6 (mm) | 0.5 | O2 (mm) | 1.03 |
| W2 (mm) | 0.1 | PBL1 (mm) | 7.88 |
| W3 (mm) | 0.12 | PBL2 (mm) | 5.0 |
| W4 (mm) | 0.12 | WN4 (mm) | 0.02 |
| W6 (mm) | 0.1 | | |

It should be noted that T2, T3, T4 and T6 defined in the 2nd Embodiment can be regarded as T defined in the present disclosure, D2, D3, D4 and D6 defined in the 2nd Embodiment can be regarded as D defined in the present disclosure, W2, W3, W4 and W6 defined in the 2nd Embodiment can be regarded as W defined in the present disclosure, O1 and O2 defined in the 2nd Embodiment can be regarded as O defined in the present disclosure, PBL1 and PBL2 defined in the 2nd Embodiment can be regarded as PBL defined in the present disclosure, and WN4 defined in the 2nd Embodiment can be regarded as WN defined in the present disclosure.

### 3rd Embodiment

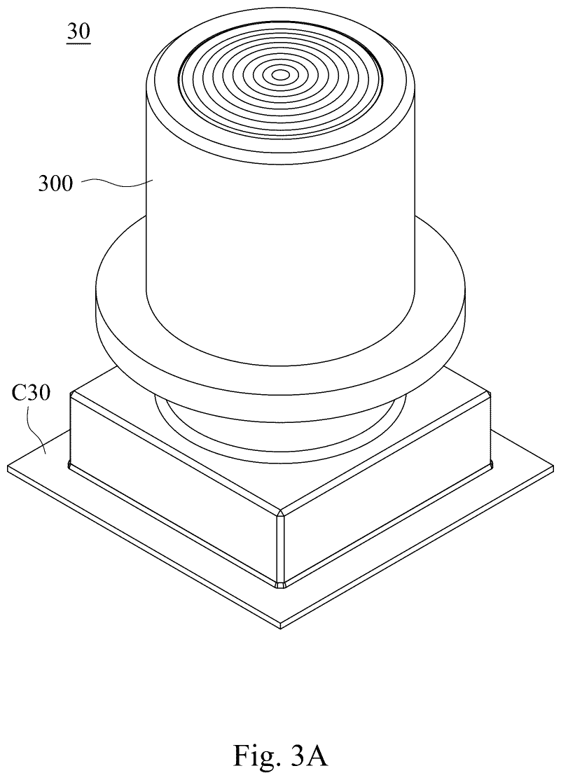

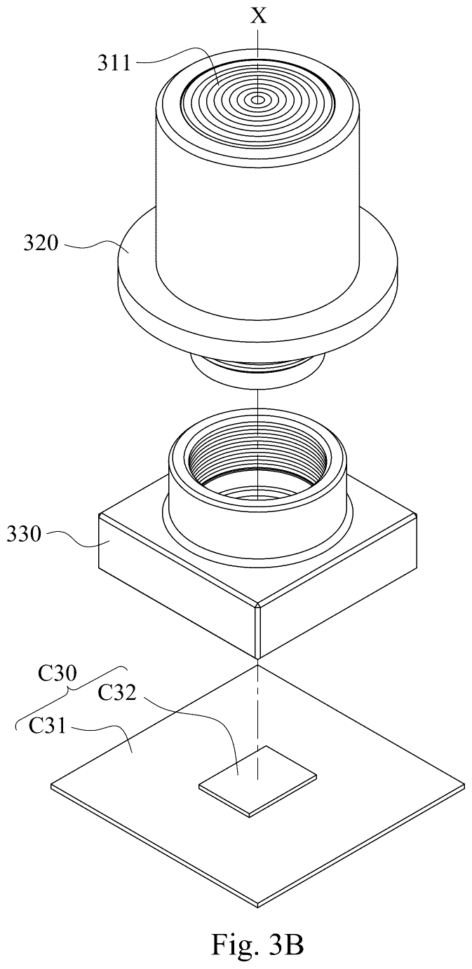

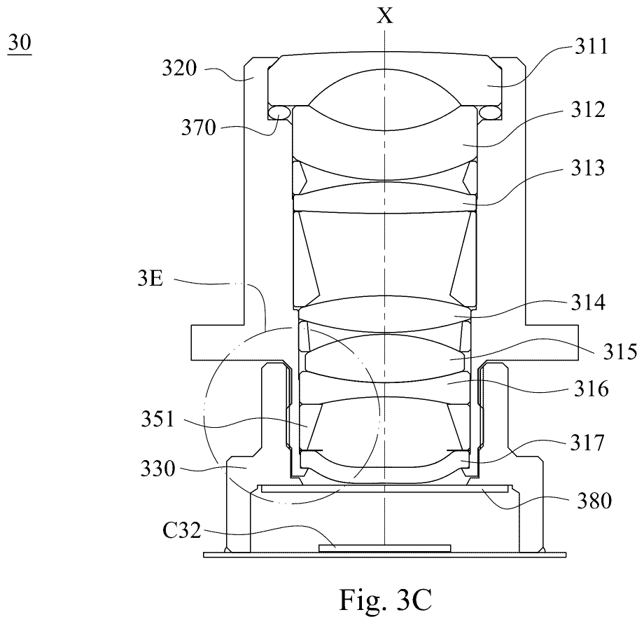

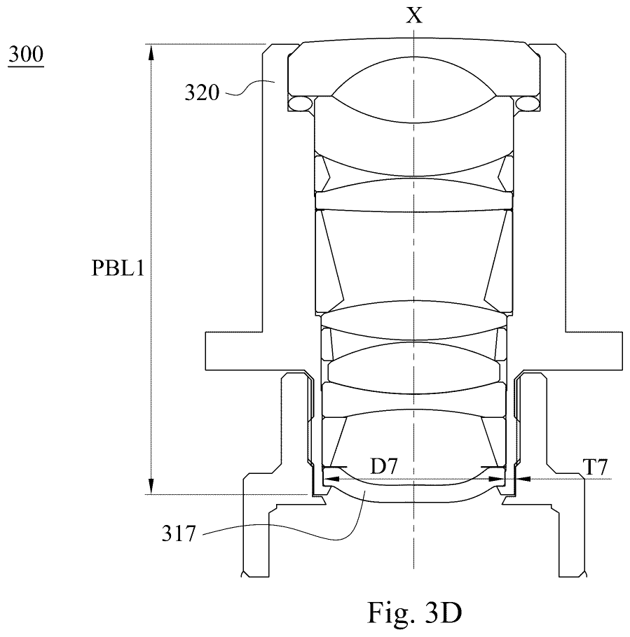

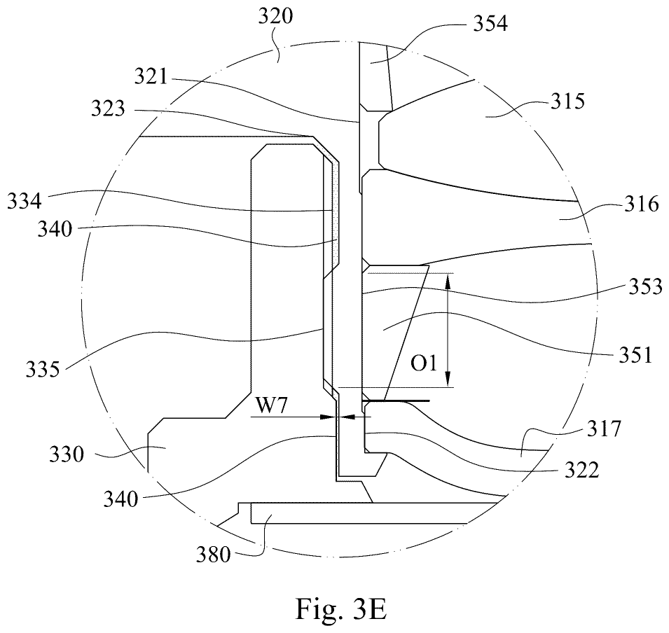

FIG. 3A is a schematic view of a camera module 30 according to the 3rd Embodiment of the present disclosure. In FIG. 3A, the camera module 30 includes an imaging lens assembly 300 and an element carrier C30.

FIG. 3B is an exploded view of the camera module 30 according to the 3rd Example in FIG. 3A, FIG. 3C is a cross-sectional view of the camera module 30 according to the 3rd Example in FIG. 3A, and FIG. 3D is a cross-sectional view of the imaging lens assembly 300 according to the 3rd Example of the present disclosure. In FIG. 3B to FIG. 3D, the imaging lens assembly 300 includes a plurality of lens elements, a plastic lens barrel 320, a frame element 330 and a first annular structure (its reference numeral is omitted), wherein a first annular element 351 forms the first annular structure. The lens elements are, arranged in order along an optical axis X, a first lens element 311, a second lens element 312, a third lens element 313, a fourth lens element 314, a fifth lens element 315, a sixth lens element 316 and a seventh lens element 317. The frame element 330 is fixed to the plastic lens barrel 320. Moreover, a hardness of the frame element 330 can be greater than a hardness of the plastic lens barrel 320, and a hardness of the first annular element 351 can be greater than the hardness of the plastic lens barrel 320.

In detail, the element carrier C30 can include an electronic element carrier C31 and an image sensor C32, and the frame element 330 of the imaging lens assembly 300 is fixed in the element carrier C30.

Specifically, the first lens element 311 is a glass lens element, the second lens element 312, the third lens element 313, the fourth lens element 314, the fifth lens element 315, the sixth lens element 316 and the seventh lens element 317 are plastic lens elements. The plastic lens elements are disposed corresponding to the glass lens element, that is, the first lens element 311 is disposed corresponding to the second lens element 312. Further, the plastic lens elements (i.e. the second lens element 312, the third lens element 313, the fourth lens element 314, the fifth lens element 315, the sixth lens element 316 and the seventh lens element 317) are disposed in the plastic lens barrel 320.

Moreover, the camera module 30 can further include a sealing element 370, and the sealing element 370 is disposed between the first lens element 311 and the plastic lens barrel 320. Further, the camera module 30 can further include a filter 380, and the filter 380 is disposed on an image side of the imaging lens assembly 300.

FIG. 3E is an enlarged view of zone 3E of the camera module 30 according to the 3rd Example in FIG. 3C. In FIG. 3C and FIG. 3E, the plastic lens barrel 320 includes a first inner lateral surface 321 and a first outer lateral surface 323, the first inner lateral surface 321 surrounds the optical axis X, and the seventh lens element 317 is physically contacted with a first area 322 of the first inner lateral surface 321. The first outer lateral surface 323 is disposed corresponding to the first inner lateral surface 321, and farther away from the plastic lens element than the first inner lateral surface 321 from the plastic lens element.

The frame element 330 includes a second inner lateral surface 334, the second inner lateral surface 334 surrounds the optical axis X and faces towards the first outer lateral surface 323, and the second inner lateral surface 334 is physically contacted with a second area 335 of the first outer lateral surface 323. A gap 340 is formed between the first outer lateral surface 323 and the second inner lateral surface 334, the gap 340 extends along the optical axis X from the second area 335, and the gap 340 corresponds to the first area 322. Moreover, the second area 335 may not overlap with the first area 322 in a direction perpendicular to the optical axis X.

The imaging lens assembly 300 can further include a first annular element 351 which forms the annular structure. The annular structure is disposed on the first inner lateral surface 321, the annular structure corresponds to the second area 335, and the annular structure surrounds the optical axis X and extends in a direction away from the frame element 330.

The annular structure can be physically contacted with a third area 353 of the first inner lateral surface 321, wherein the first inner lateral surface 321 and the annular structure can be formed integrally. Moreover, the annular structure is disposed in the third area 353 of the first inner lateral surface 321. Further, a number of the annular structure can be plural, and the annular structure can be disposed adjacent to at least one of the plastic lens elements.

Furthermore, the imaging lens assembly 300 can further include a second annular element 354 between the fourth lens element 314 and the fifth lens element 315 to position the fourth lens element 314 and the fifth lens element 315. In FIG. 3E, the second inner lateral surface 334 can include threads so that the second area 335 of the plastic lens barrel 320 is physically contacted with the frame element 330. Specifically, the frame element 330 can be made of thermal conductive plastic, and the thermal conductive plastic is mixed with thermal conductive components, such as graphite, carbon fiber, metal powder, etc. A function for electromagnetic interference (EMI) shielding of the thermal conductive plastic can be further obtained so as to reduce electromagnetic signal interferences to the image sensor C32. The plastic lens barrel 320 and the first annular element 351 can be made of plastic.

In FIG. 3D and FIG. 3E, on a cross-section parallel to the optical axis X, the seventh lens element 317 defines a lens diameter as D7, a lens barrel thickness of the plastic lens barrel 320 in the first area 322 corresponding to the seventh lens element 317 is T7, a minimum width of the gap 340 corresponding to the first area 322 by the seventh lens element 317 is W7. Moreover, in a direction parallel to the optical axis X, an overlapping length of the third area 353 between the sixth lens element 316 and the seventh lens element 317 and the second area 335 is O1, a length of the plastic lens barrel 320 is PBL1, and the aforementioned parameters satisfy the following conditions in Table 3.

TABLE 3
3rd Embodiment

| | | | |
|---|---|---|---|
| D7 (mm) | 9.6 | T7/D7 | 0.05 |
| T7 (mm) | 0.5 | O1/PBL1 | 0.093 |
| W7 (mm) | 0.05 | | |
| O1 (mm) | 2.22 | | |
| PBL1 (mm) | 23.8 | | |

It should be noted that T7 defined in the 3rd Embodiment can be regarded as T defined in the present disclosure, D7 defined in the 3rd Embodiment can be regarded as D defined in the present disclosure, W7 defined in the 3rd Embodiment can be regarded as W defined in the present disclosure, O1 defined in the 3rd Embodiment can be regarded as O defined in the present disclosure, and PBL1 defined in the 3rd Embodiment can be regarded as PBL defined in the present disclosure.

### 4th Embodiment

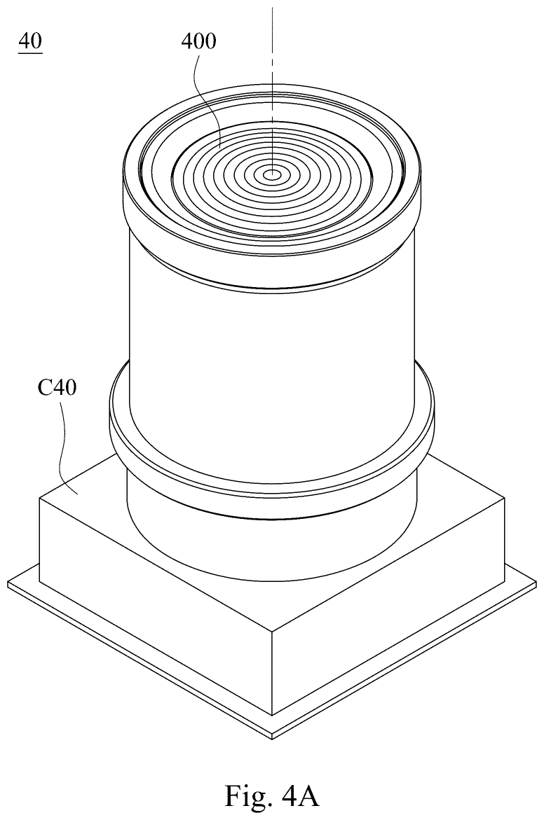

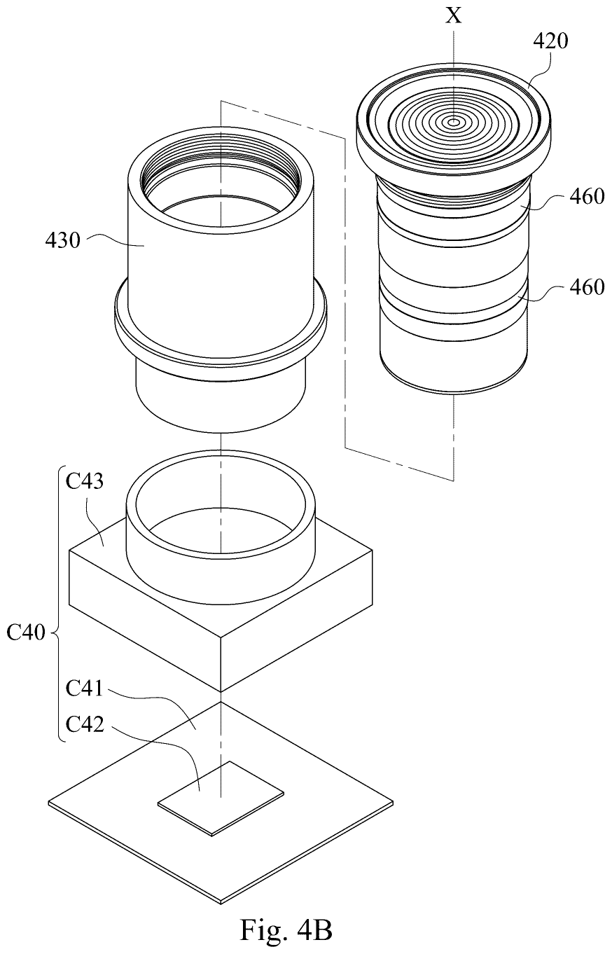

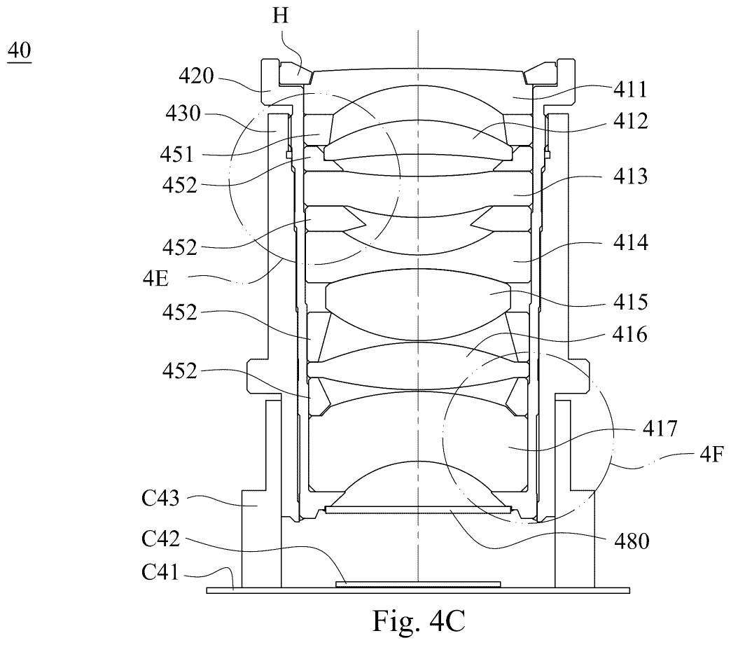

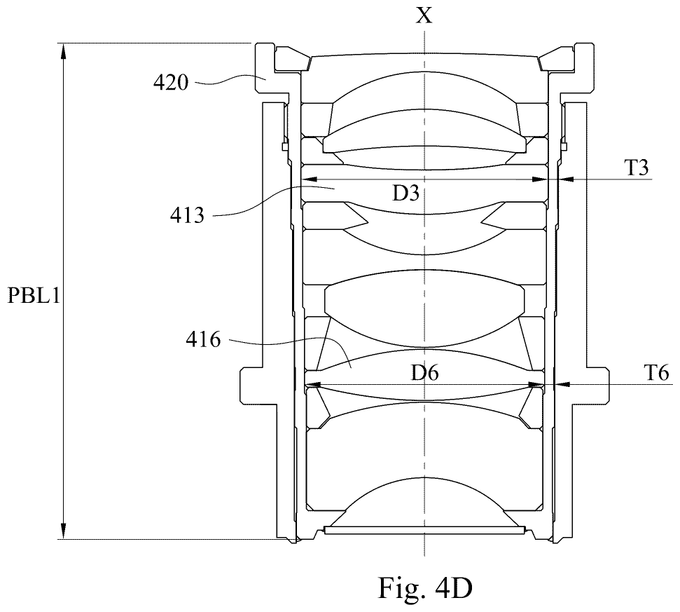

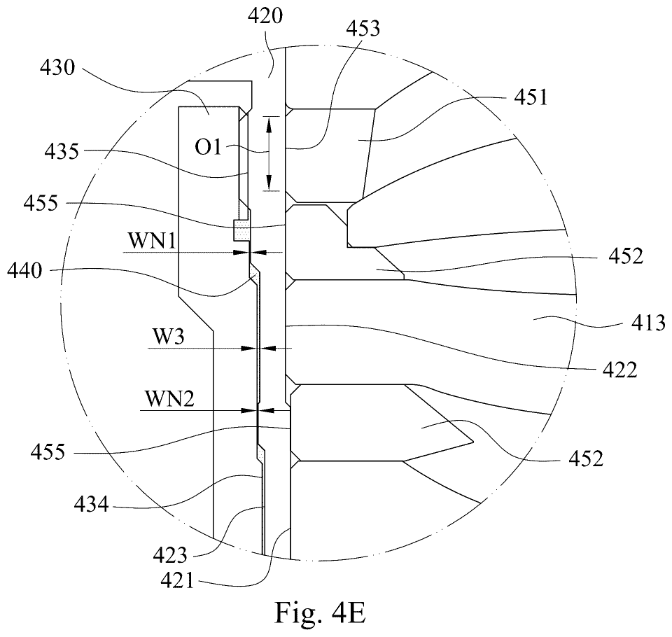

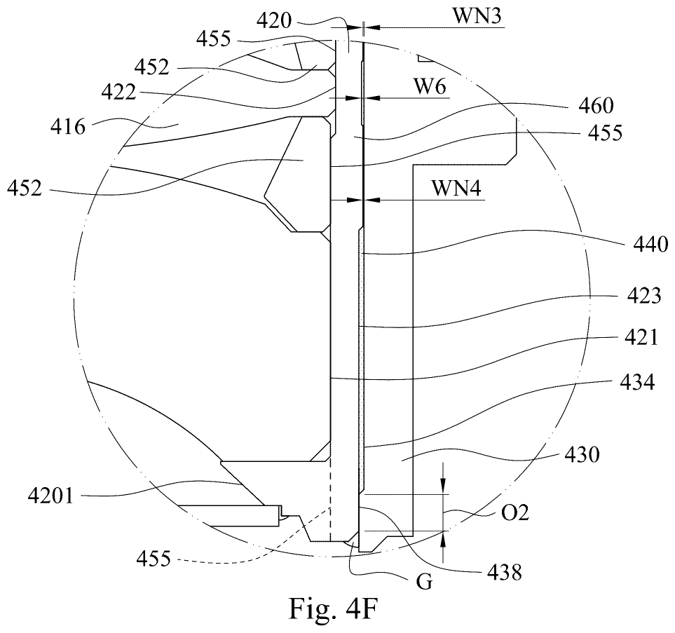

FIG. 4A is a schematic view of a camera module 40 according to the 4th Embodiment of the present disclosure. In FIG. 4A, the camera module 40 includes an imaging lens assembly 400 and an element carrier C40.

FIG. 4B is an exploded view of the camera module 40 according to the 4th Example in FIG. 4A, FIG. 4C is a cross-sectional view of the camera module 40 according to the 4th Example in FIG. 4A, and FIG. 4D is a cross-sectional view of the imaging lens assembly 400 according to the 4th Example of the present disclosure. In FIG. 4B to FIG. 4D, the imaging lens assembly 400 includes a plurality of lens elements, a plastic lens barrel 420, a frame element 430 and a first annular structure (its reference numeral is omitted), wherein a first annular element 451 forms the first annular structure. The lens elements are, arranged in order along an optical axis X, a first lens element 411, a second lens element 412, a third lens element 413, a fourth lens element 414, a fifth lens element 415, a sixth lens element 416 and a seventh lens element 417. The frame element 430 is fixed to the plastic lens barrel 420. Moreover, the imaging lens assembly 400 can further include a second annular structure (its reference numeral is omitted). In the 4th Embodiment, a number of the second annular structures is four, and the second annular structures are formed by four second annular elements 452. Further, a hardness of the frame element 430 can be greater than a hardness of the plastic lens barrel 420, and a hardness of the first annular element 451 can be greater than the hardness of the plastic lens barrel 420.

In detail, the element carrier C40 can include an electronic element carrier C41, an image sensor C42 and a base C43, and the frame element 430 of the imaging lens assembly 400 is fixed in the element carrier C40.

Moreover, the imaging lens assembly 400 can further include two protruding structures 460.

Specifically, the first lens element 411, the second lens element 412, the fourth lens element 414, the fifth lens element 415 and the seventh lens element 417 are glass lens elements. The third lens element 413 and the sixth lens element 416 are plastic lens elements. The plastic lens elements are disposed corresponding to the glass lens elements, that is, the second lens element 412 and the fourth lens element 414 are respectively disposed corresponding to the third lens element 413, and the fifth lens element 415 and the seventh lens element 417 are respectively disposed corresponding to the sixth lens element 416. The plastic lens elements (i.e. the third lens element 413 and the sixth lens element 416) are disposed in the plastic lens barrel 420.

Moreover, the imaging lens assembly 400 can further include a lens retainer H, the lens retainer H is disposed in the plastic lens barrel 420 and physically contacted with at least one of the lens elements and the plastic lens barrel 420. Specifically, the lens retainer H is configured to position the first lens element 411.

Further, the camera module 40 can further include a filter 480, and the filter 480 is disposed on an image side of the imaging lens assembly 400.

FIG. 4E is an enlarged view of zone 4E of the camera module 40 according to the 4th Example in FIG. 4C, and FIG. 4F is an enlarged view of zone 4F of the camera module 40 according to the 4th Example in FIG. 4C. In FIG. 4C, FIG. 4E and FIG. 4F, the plastic lens barrel 420 includes a first inner lateral surface 421 and a first outer lateral surface 423, the first inner lateral surface 421 of the plastic lens barrel 420 surrounds the optical axis X. Further, the third lens element 413 and the sixth lens element 416 are respectively physically contacted with the first areas 422 of the first inner lateral surface 421 corresponding to the third lens element 413 and the sixth lens element 416. The first outer lateral surface 423 is disposed corresponding to the first inner lateral surface 421, and farther away from the plastic lens elements than the first inner lateral surface 421 from the plastic lens elements.

The frame element 430 includes a second inner lateral surface 434, the second inner lateral surface 434 surrounds the optical axis X and faces towards the first outer lateral surface 423, and the second inner lateral surface 434 is physically contacted with a second area 435 of the first outer lateral surface 423. Specifically, the frame element 430 is physically contacted with the second area 435 of the plastic lens barrel 420, and the plastic lens barrel 420 matches the size of the frame element 430 to achieve the physical contact.

The imaging lens assembly 400 includes gaps 440. The gaps 440 are formed between the first outer lateral surface 423 and the second inner lateral surface 434, each of the gaps 440 extends along the optical axis X from the second area 435, and the gaps 440 respectively correspond to the first areas 422 corresponding to the gaps 440. Moreover, the second area 435 may not overlap with the first area 422 in a direction perpendicular to the optical axis X.

The imaging lens assembly 400 can further include a first annular element 451 which forms the first annular structure. The first annular structure is disposed on the first inner lateral surface 421, the first annular structure corresponds to the second area 435, and the first annular structure surrounds the optical axis X and extends in a direction away from the frame element 430.

Moreover, the first annular structure can be physically contacted with a third area 453 of the first inner lateral surface 421, wherein the first inner lateral surface 421 and the first annular structure can be formed integrally. Moreover, the first annular structure is disposed in the third area 453 of the first inner lateral surface 421.

The second annular structures formed by second annular elements 452 are respectively disposed on the first inner lateral surface 421, the second annular structures correspond to one of the gaps 440, the second annular structures surround the optical axis X and extend in a direction away from the gaps 440. On a cross-section parallel to the optical axis, a width of the one of the gaps 440 corresponding to one of the second annular structures can be narrower than a width of the gap 420 corresponding and adjacent to the first area 422.

Moreover, in FIG. 4F, a surface (i.e. the first inner lateral surface 421) facing towards the optical axis X of the plastic lens barrel 420 can include a first annular structure 4201, the first annular structure 4201 surrounds the optical axis X and extends in a direction away from the frame element 430 so as to position the seventh lens element 417. Further, the first annular structure 4201 is disposed in sub-third areas 455 of the first inner lateral surface 421. The first annular structure 4201 is physically contacted with the sub-third areas 455 of the first inner lateral surface 421 (in FIG. 4F, the sub-third areas 455 and the first annular structure 4201 are formed integrally).

In FIG. 4F, the imaging lens assembly 400 can further include a glue G, the glue G is disposed between the second inner lateral surface 434 and the first outer lateral surface 423 to position the frame element 430 and the plastic lens barrel 420.

In FIG. 4F, a protruding structure 460 is disposed on the first outer lateral surface 423 of the plastic lens barrel 420 and corresponds to the second annular structures, the protruding structure 460 protrudes in a direction away from the second annular structures, and the protruding structure 460 maintains the gaps 440 with the frame element 430.

Specifically, the frame element 430 and the first annular element 451 can be made of ceramic, the second annular elements 452 can be made of plastic, and the plastic lens barrel 420 can be made of plastic.

In FIG. 4D to FIG. 4F, on a cross-section parallel to the optical axis X, the third lens element 413 defines a lens diameter as D3, the sixth lens element 416 defines a lens diameter as D6, a lens barrel thickness of the plastic lens barrel 420 in the first area 422 corresponding to the third lens element 413 is T3, a lens barrel thickness of the plastic lens barrel 420 in the first area 422 corresponding to the sixth lens element 416 is T6, a minimum width of the gap 440 corresponding to the first area 422 by the third lens element 413 is W3, a minimum width of the gap 440 corresponding to the first area 422 by the sixth lens element 416 is W6, a minimum width of the gap 440 corresponding to the second annular structures and on the image side of the second lens element 412 is WN1, a minimum width of the gap 440 corresponding to the second annular structures and on the image side of the third lens element 413 is WN2, a minimum width of the gap 440 corresponding to the second annular structures and on the image side of the fifth lens element 415 is WN3, and a minimum width of the gap 440 corresponding to the second annular structures and on the image side of the sixth lens element 416 is WN4. Moreover, in a direction parallel to the optical axis X, an overlapping length of the third area 453 between the first lens element 411 and the second lens element 412 and the second area 435 is O1, an overlapping length of the sub-third area 422 and a sub-second area 438 is O2, a length of the plastic lens barrel 420 is PBL1, and the aforementioned parameters satisfy the following conditions in Table 4.

TABLE 4
4th Embodiment

| | | | |
|---|---|---|---|
| D3 (mm) | 13.0 | T3/D3 | 0.038 |
| D6 (mm) | 13.4 | T6/D6 | 0.037 |
| T3 (mm) | 0.5 | O1/PBL1 | 0.054 |
| T6 (mm) | 0.5 | O2/PBL1 | 0.026 |
| W3 (mm) | 0.25 | WN1 (mm) | 0.01 |
| W6 (mm) | 0.25 | WN2 (mm) | 0.01 |
| O1 (mm) | 1.44 | WN3 (mm) | 0.01 |
| O2 (mm) | 0.71 | WN4 (mm) | 0.01 |
| PBL1 (mm) | 26.85 | | |

It should be noted that T3 and T6 defined in the 4th Embodiment can be regarded as T defined in the present disclosure, D3 and D6 defined in the 4th Embodiment can be regarded as D defined in the present disclosure, W3 and W6 defined in the 4th Embodiment can be regarded as W defined in the present disclosure, O1 and 02 defined in the 4th Embodiment can be regarded as O defined in the present disclosure, PBL1 defined in the 4th Embodiment can be regarded as PBL defined in the present disclosure, and WN1, WN2, WN3 and WN4 defined in the 4th Embodiment can be regarded as WN defined in the present disclosure.

### 5th Embodiment

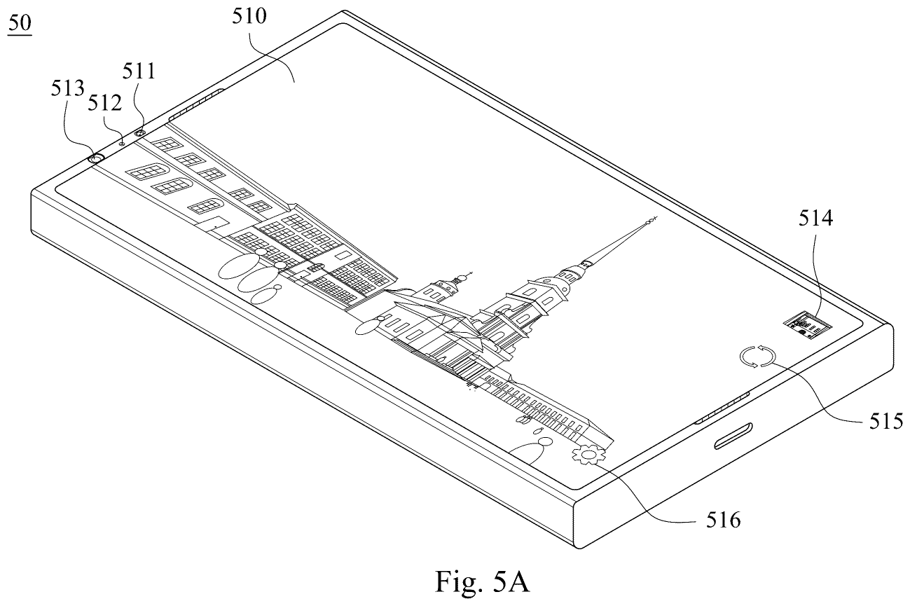

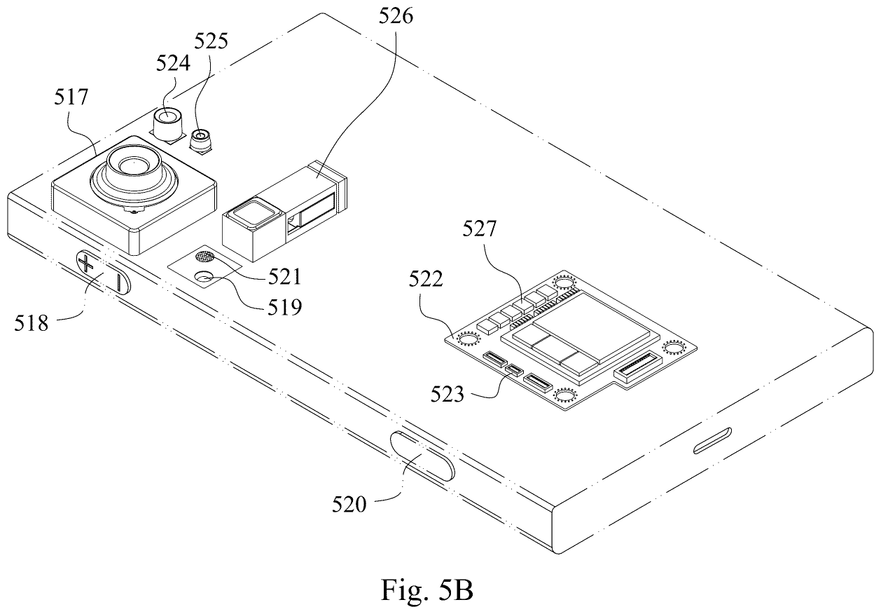

FIG. 5A is a schematic view of an electronic device 50 according to the 5th Embodiment of the present disclosure, and FIG. 5B is another schematic view of the electronic device 50 according to the 5th Embodiment in FIG. 5A. In FIG. 5A and FIG. 5B, the electronic device 50 is a smart phone, and the electronic device 50 includes a camera module and a imaging controlling interface 510, wherein the camera module includes a imaging lens assembly (not shown) and an element carrier (not shown), wherein the frame element (not shown) of the imaging lens assembly is fixed in the element carrier. The imaging lens assembly includes a plurality of lens elements (not shown), a plastic lens barrel (not shown), a frame element and a gap (not shown). Moreover, the imaging lens assembly can be the imaging lens assembly according to any one of the aforementioned 1st Embodiment to the 4th Embodiment, but the present disclosure is not limited thereto.

In detail, the imaging controlling interface 510 can be a touch function, a user enters a shooting mode via the imaging controlling interface 510, wherein the imaging controlling interface 510 is configured to display an image, and the shooting angle can be manually adjusted to switch to different imaging lens assemblies. In detail, the imaging controlling interface 510 includes an image replay button 514, a camera module switching button 515, an integrated menu button 516 and a zoom controlling button 518. Furthermore, users enter a shooting mode via the imaging controlling interface 510 of the electronic device 50, the camera module switching button 515 can be flexibly configured to switch one of the front camera module 511, the Time-Of-Flight (TOF) camera module 513, the wide angle camera module 517, the telephoto camera module 526, the ultra-wide angle camera module 524 and the macro-image capturing camera module 525 to capture the image, the zoom controlling button 518 is configured to adjust the zoom, the users use the focus capturing button 520 to undergo image capturing after capturing the images and confirming one of the front camera module 511, the TOF camera module 513, the wide angle camera module 517, the telephoto camera module 526, the ultra-wide angle camera module 524 and the macro-image capturing camera module 525, the users can view the images by the image replay button 514 after undergoing image capturing, and the integrated menu button 516 is configured to adjust the details of the image capturing (such as timed photo, photo ratio, and etc.).

The electronic device 50 can further include a reminding light 512, and the reminding light 512 is disposed on the front of the electronic device 50 which can be configured to remind the users of unread messages, missed calls and the condition of the phone.

Moreover, after entering the shooting mode via the imaging controlling interface 510 of the electronic device 50, the imaging light is gathered on the image sensor via the image capturing apparatus, and an electronic signal about an image is output to an image signal processor (ISP) (not shown) of a single chip system (not shown). The single chip system can further include a random access memory (RAM) (not shown), a central processing unit (not shown) and a storage unit (not shown). Also, the single chip system can further include, but not be limited to, a display, a controlling unit, a read-only memory (ROM), or the combination thereof.

Further, the electronic device 50 can further include an image software processor and an image signal processor, and further integrates the image software processor, the image signal processor, a position locator, a transmit signal processor, a gyroscope, a storage unit and a random access memory in the single chip system.

To meet a specification of the electronic device 50, the electronic device 50 can further include an optical anti-shake mechanism (not shown). Furthermore, the electronic device 50 can further include at least one focusing assisting element 521 and at least one sensing element (not shown). The focusing assisting element 521 can include a flash element 519 for compensating a color temperature, an infrared distance measurement component (not shown), a laser focus module (not shown), etc. The sensing element can have functions for sensing physical momentum and kinetic energy, such as an accelerator, a gyroscope, a Hall Effect Element, a position locator, a signal transmitter module, to sense shaking or jitters applied by hands of the user or external environments. Accordingly, the electronic device 50 equipped with an auto-focusing mechanism and the optical anti-shake mechanism can be enhanced to achieve the superior image quality. Furthermore, the electronic device 50 according to the present disclosure can have a capturing function with multiple modes, such as taking optimized selfies, high dynamic range (HDR) under a low light condition, 4K resolution recording, etc. Furthermore, the users can visually see a captured image of the camera through the imaging controlling interface 510 and manually operate the view finding range on the imaging controlling interface 510 to achieve the autofocus function of what you see is what you get.

Moreover, the camera modules, the optical anti-shake mechanism, the sensing element, the focusing assisting element 521 and an electronic element 527 can be disposed on a circuit board 522 and electrically connected to the associated components via a connector 523 to perform a capturing process, wherein the circuit board 522 can be a flexible printed circuit board (FPC). Since the current electronic devices, such as smart phones, have a tendency of being compact, the way of firstly disposing the image capturing apparatus and related components on the flexible printed circuit board and secondly integrating the circuit thereof into the main board of the electronic device via the connector can satisfy the requirements of the mechanical design and the circuit layout of the limited space inside the electronic device, and obtain more margins. The autofocus function of the image capturing apparatus can also be controlled more flexibly via the touch screen of the electronic device. In other embodiments (not shown), the sensing elements and the focusing assisting modules can also be disposed on the main board of the electronic device or carrier boards of other types according to requirements of the mechanical design and the circuit layout.

### 6th Embodiment

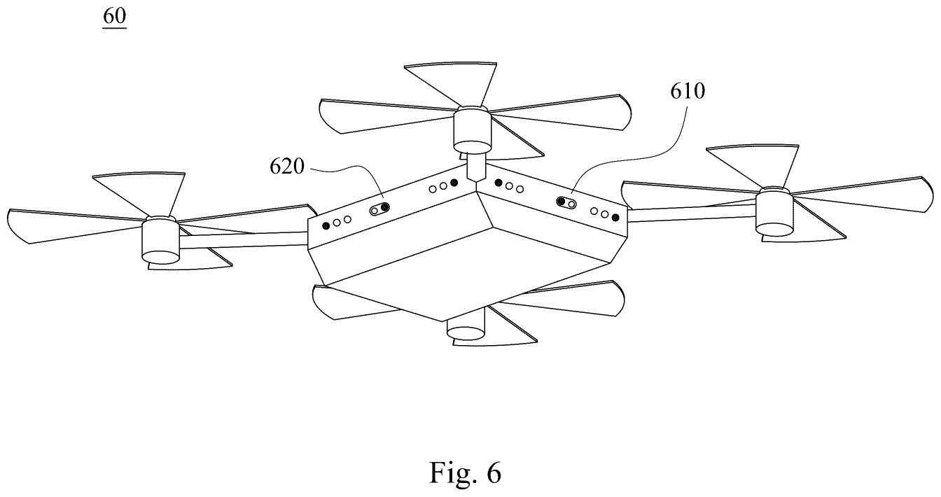

FIG. 6 is a schematic view of an electronic device applied to a drone 60 according to the 6th Embodiment of the present disclosure. In FIG. 6, an electronic device (not shown) includes a camera module, wherein the camera module includes an imaging lens assembly (not shown) and an element carrier (not shown), and the frame element (not shown) of the imaging lens assembly is fixed in the element carrier. Moreover, the camera module can include the imaging lens assembly according to any one of the aforementioned 1st Embodiment to the 4th Embodiment, but the present disclosure is not limited thereto.

In the 6th Embodiment, the camera modules are a front camera module 610 and a lateral camera module 620, respectively.

Specifically, the front camera module 610 is disposed on a front end of the drone 60, and the lateral camera module 620 is disposed on a side of the drone 60. Therefore, the electronic device can be configured to cope with the complicated environmental light.

### 7th Embodiment

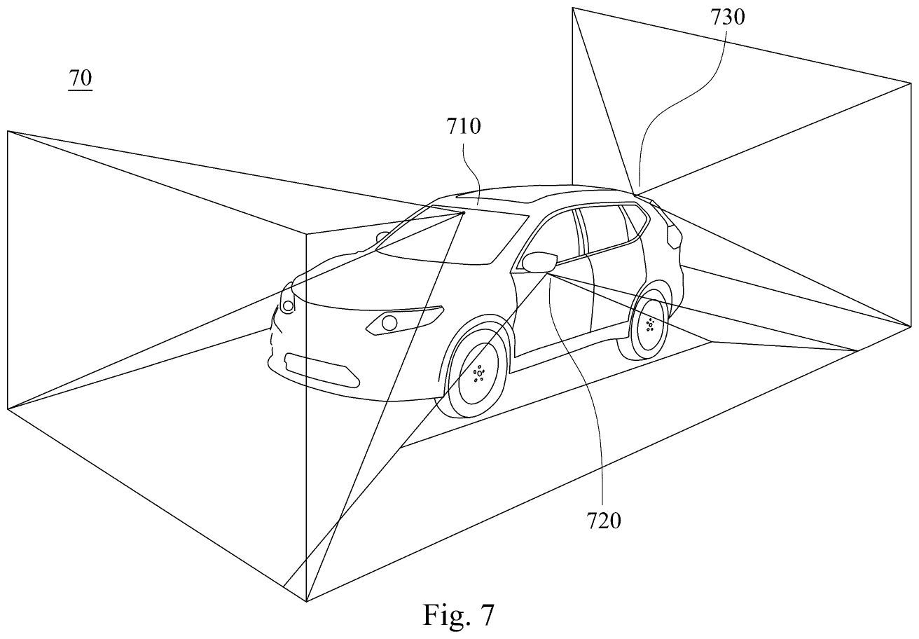

FIG. 7 is a schematic view of an electronic device applied to a vehicle 70 according to the 7th Embodiment of the present disclosure. In FIG. 7, an electronic device (not shown) includes a camera module, wherein the camera module includes an imaging lens assembly (not shown) and an element carrier (not shown), and the frame element (not shown) of the imaging lens assembly is fixed in the element carrier. Moreover, the camera module can include the imaging lens assembly according to any one of the aforementioned 1st Embodiment to the 4th Embodiment, but the present disclosure is not limited thereto.

In the 7th Embodiment, the camera modules are a front camera module 710, a lateral camera module 720, and a rear camera module 730, respectively.

The front camera module 710, the lateral camera module 720, and the rear camera module 730 are disposed on a front end, a lateral, and a rear end of the vehicle 70, respectively. It is favorable for the drivers obtaining the external space information of the vehicle 70. Therefore, more visual angles can be provided to reduce the blind spot, so that the driving safety can be improved.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging lens assembly, comprising:
a plurality of lens elements arranged in order along an optical axis, comprising:
a glass lens element; and
a first plastic lens element disposed corresponding to the glass lens element;
a plastic lens barrel, wherein the first plastic lens element is disposed in the plastic lens barrel, and the plastic lens barrel comprises:
a first inner lateral surface surrounding the optical axis, wherein the first plastic lens element is physically contacted with a first area of the first inner lateral surface; and
a first outer lateral surface disposed corresponding to the first inner lateral surface, and farther away from the first plastic lens element than the first inner lateral surface from the first plastic lens element;
a frame element fixed to the plastic lens barrel, and comprising:
a second inner lateral surface surrounding the optical axis and facing towards the first outer lateral surface, wherein the second inner lateral surface is physically contacted with a second area of the first outer lateral surface; and
a gap formed between the first outer lateral surface and the second inner lateral surface, wherein the gap extends along the optical axis from the second area, and the gap corresponds to the first area;
wherein the imaging lens assembly further comprises at least one first annular structure, which is disposed on the first inner lateral surface, the at least one first annular structure corresponds to the second area, and the at least one first annular structure surrounds the optical axis and extends in a direction away from the frame element.

2. The imaging lens assembly of claim 1, further comprising:
a first annular element forming the at least one first annular structure, wherein the first annular element is physically contacted with a third area of the first inner lateral surface.

3. The imaging lens assembly of claim 2, wherein a hardness of the first annular element is greater than a hardness of the plastic lens barrel.

4. The imaging lens assembly of claim 1, wherein the first inner lateral surface and the at least one first annular structure are formed integrally.

5. The imaging lens assembly of claim 1, wherein the frame element comprises an extending structure, the extending structure extends in a direction close to the optical axis, and one of the lens elements relies on the extending structure.

6. The imaging lens assembly of claim 1, wherein a hardness of the frame element is greater than a hardness of the plastic lens barrel.

7. The imaging lens assembly of claim 1, wherein the second area does not overlap with the first area in a direction perpendicular to the optical axis.

8. The imaging lens assembly of claim 1, wherein on a cross-section parallel to the optical axis, the first plastic lens element defines a lens diameter as D, a lens barrel thickness of the plastic lens barrel in the first area is T, and the following condition is satisfied:
$$0.018 \leq T / D \leq 0.6 .$$

9. The imaging lens assembly of claim 8, wherein on the cross-section parallel to the optical axis, the first plastic lens element defines the lens diameter as D, the lens barrel thickness of the plastic lens barrel in the first area is T, and the following condition is satisfied:
$$0.02 \leq T / D \leq 0.22 .$$

10. The imaging lens assembly of claim 8, wherein on the cross-section parallel to the optical axis, the lens barrel thickness of the plastic lens barrel in the first area is T, and the following condition is satisfied:
$$0.22 mm \leq T \leq 3.0 mm .$$

11. The imaging lens assembly of claim 1, wherein on a cross-section parallel to the optical axis, a minimum width of the gap corresponding to the first area is W, and the following condition is satisfied:
$$0.0012 mm \leq W \leq 0.24 mm .$$

12. The imaging lens assembly of claim 1, wherein the at least one first annular structure is disposed in a third area of the first inner lateral surface, on a cross-section parallel to the optical axis, an overlapping length of the third area and the second area is O, a length of the plastic lens barrel is PBL, and the following condition is satisfied:
$$0.012 \leq O / PBL \leq 0.42 .$$

13. The imaging lens assembly of claim 1, wherein a number of the at least one first annular structure is plural.

14. The imaging lens assembly of claim 1, further comprising:
a retaining element retaining the plastic lens barrel and the frame element, wherein the retaining element is disposed in the frame element, and the retaining element is physically contacted with at least one of the lens elements and the plastic lens barrel.

15. The imaging lens assembly of claim 1, wherein the lens elements further comprise:
a second plastic lens element, wherein the at least one first annular structure is disposed between the second plastic lens element and the first plastic lens element;
wherein the second plastic lens element is physically contacted with the first inner lateral surface, and the second plastic lens element corresponds to the gap.

16. The imaging lens assembly of claim 1, wherein the at least one first annular structure is disposed adjacent to the first plastic lens element.

17. The imaging lens assembly of claim 1, further comprising:
a second annular structure disposed on the first inner lateral surface and corresponding to the gap, wherein the second annular structure surrounds the optical axis and extends in a direction away from the gap;
wherein on a cross-section parallel to the optical axis, a width of the gap corresponding to the second annular structure is narrower than a width of the gap corresponding to the first area, a minimum width of the gap corresponding to the second annular structure is WN, and the following condition is satisfied:
$$0.004 mm \leq W N \leq 0.05 mm .$$

18. The imaging lens assembly of claim 17, wherein the minimum width of the gap corresponding to the second annular structure is WN, and the following condition is satisfied:
$$0.005 mm \leq W N \leq 0.04 mm .$$

19. The imaging lens assembly of claim 17, further comprising:
a protruding structure disposed on the first outer lateral surface of the plastic lens barrel and corresponding to the second annular structure, wherein the protruding structure protrudes in a direction away from the second annular structure, and the protruding structure maintains the gap with the frame element.

20. The imaging lens assembly of claim 19, wherein the protruding structure comprises a plurality of sub-protruding structures, and the sub-protruding structures are arranged at intervals.

21. A camera module, comprising:
the imaging lens assembly of claim 1; and
an element carrier, wherein the frame element of the imaging lens assembly is fixed in the element carrier.

22. An electronic device, comprising:
the camera module of claim 21.

23. An imaging lens assembly, comprising:
a plurality of lens elements arranged in order along an optical axis, comprising:
a glass lens element; and
a first plastic lens element disposed corresponding to the glass lens element;
a plastic lens barrel, wherein the first plastic lens element is disposed in the plastic lens barrel, and the plastic lens barrel comprises:
a first inner lateral surface surrounding the optical axis, wherein the first plastic lens element is physically contacted with a first area of the first inner lateral surface; and
a first outer lateral surface disposed corresponding to the first inner lateral surface, and farther away from the first plastic lens element than the first inner lateral surface from the first plastic lens element;
a frame element fixed to the plastic lens barrel, and comprising:
a second inner lateral surface surrounding the optical axis and facing towards the first outer lateral surface, wherein the second inner lateral surface is physically contacted with a second area of the first outer lateral surface; and
a gap formed between the first outer lateral surface and the second inner lateral surface, wherein the gap extends along the optical axis from the second area, and the gap corresponds to the first area;
wherein the imaging lens assembly further comprises at least one annular structure, which is disposed on the first inner lateral surface, the at least one annular structure corresponds to the gap, and the at least one annular structure surrounds the optical axis and extends in a direction away from the gap;
wherein on a cross-section parallel to the optical axis, a width of the gap corresponding to the at least one annular structure is narrower than a width of the gap corresponding to the first area, a minimum width of the gap corresponding to the at least one annular structure is WN, and the following condition is satisfied:
$$0.004 mm \leq W N \leq 0.05 mm .$$

24. The imaging lens assembly of claim 23, further comprising:
a protruding structure disposed on the first outer lateral surface of the plastic lens barrel and corresponding to the at least one annular structure, wherein the protruding structure protrudes in a direction away from the at least one annular structure, and the protruding structure maintains the gap with the frame element.

25. The imaging lens assembly of claim 24, wherein the protruding structure comprises a plurality of sub-protruding structures, and the sub-protruding structures are arranged at intervals.

26. The imaging lens assembly of claim 23, wherein on the cross-section parallel to the optical axis, a minimum width of the gap corresponding to the first area is W, and the following condition is satisfied:
$$0.0012 mm \leq W \leq 0.24 mm .$$

27. The imaging lens assembly of claim 23, wherein on the cross-section parallel to the optical axis, the second area does not overlap with the first area.

28. The imaging lens assembly of claim 23, wherein on the cross-section parallel to the optical axis, the first plastic lens element defines a lens diameter as D, a lens barrel thickness of the plastic lens barrel in the first area is T, and the following condition is satisfied:
$$0.018 \leq T / D \leq 0.6 .$$

29. The imaging lens assembly of claim 23, wherein a number of the at least one annular structure is plural.

30. The imaging lens assembly of claim 23, wherein the lens elements further comprise:
a second plastic lens element, wherein the at least one annular structure is disposed between the first plastic lens element and the second plastic lens element;
wherein the second plastic lens element is physically contacted with the first inner lateral surface, and the second plastic lens element corresponds to the gap.

31. The imaging lens assembly of claim 23, wherein the at least one annular structure is disposed adjacent to the first plastic lens element.
